(19) United States
(12) Patent Application Publication
(10) Pub. No.: US 2012/0031767 A1
(43) Pub. Date: Feb. 9, 2012

(54) ZINC OXIDE AND COBALT OXIDE NANOSTRUCTURES AND METHODS OF MAKING THEREOF

(76) Inventor: Shrisudersan Jayaraman, Painted Post, NY (US)

(21) Appl. No.: 13/273,757

(22) Filed: Oct. 14, 2011

Related U.S. Application Data
(62) Division of application No. 12/549,186, filed on Aug. 27, 2009.

(51) Int. Cl. C25D 15/00; B82Y 40/00

(52) U.S. Cl. 205/109; 977/890

(57) ABSTRACT

The disclosure relates to metal oxide materials with varied nanostructural morphologies. More specifically, the disclosure relates to zinc oxide and cobalt oxide nanostructures with varied morphologies. The disclosure further relates to methods of making such metal oxide nanostructures.

This application is a divisional of U.S. patent application Ser. No. 12/549,186 filed on Aug. 27, 2009, the content of which is relied upon and incorporated herein by reference in its entirety, and the benefit of priority under 35 U.S.C. §120 is hereby claimed.

### FIELD OF THE DISCLOSURE

The disclosure relates to novel metal oxide nanostructures with varied morphologies. More specifically, the disclosure relates to zinc oxide and cobalt oxide nanostructures with varied morphologies. The disclosure further relates to methods of making such metal oxide nanostructures.

### BACKGROUND

Metal oxides, metals, mixed metals, metal alloys, metal alloy oxides, and metal hydroxides are material systems explored, in part, due to these systems having several practical and industrial applications. Metal oxides are used in a wide range of applications such as in paints, cosmetics, catalysis, and bio-implants.

Nanomaterials may possess unique properties that are not observed in the bulk material such as, for example, optical, mechanical, biochemical and catalytic properties of particles which may be related to the size of the particles. In addition to very high surface area-to-volume ratios, nanomaterials may exhibit quantum—mechanical effects that can enable applications that may not be possible using the bulk material. Moreover, the properties of a given nanomaterial may vary further depending upon the morphology of the material. The development or synthesis of each nanomaterial, including new morphologies, presents new and unique opportunities to design and develop a wide range of new and useful applications.

There are several conventional methods for the synthesis of nanomaterials, including those identified in U.S. patent application Ser. No. 12/038,847, filed Feb. 28, 2008, which is incorporated herein by reference. However, as discussed therein, conventional methods may be disadvantageous because they may be energy intensive, employ expensive capital equipment, for example, high pressure reactors, involve tedious process steps, for example, cleaning, washing and drying of powders, and use harmful chemicals.

Thus, it would be advantageous to obtain new metal oxide nanostructures and methods of making said nanostructures, particularly in large quantities in an economically viable fashion.

### SUMMARY

The disclosure relates to novel metal oxide nanostructures with varied morphologies, and more particularly to zinc oxide and cobalt oxide nanostructures. The disclosure further relates to methods of making the novel nanostructures. In various embodiments, the methods are electrochemical methods.

### BRIEF DESCRIPTION OF THE DRAWINGS

The accompanying drawings are included to provide a further understanding of the disclosure, and are incorporated in and constitute a part of this specification. The drawings are not intended to be restrictive, but rather are provided to illustrate exemplary embodiments and, together with the description, serve to explain the principles disclosed herein.

FIGS. 1a-1d are SEM micrographs of zinc oxide nanostructures made according to one embodiment of the disclosure and as disclosed in Example 1A.

FIG. 2a-2d are SEM micrographs of zinc oxide nanostructures made according to one embodiment of the disclosure and as disclosed in Example 1B.

FIGS. 3a-3b are SEM micrographs of zinc oxide nanostructures made according to one embodiment of the disclosure and as disclosed in Example 1C.

FIGS. 4a-4d are SEM micrographs of zinc oxide nanostructures made according to one embodiment of the disclosure and as disclosed in Example 1D.

FIGS. 5a-5b are optical images of the zinc cathodes made according to one embodiment of the disclosure and as disclosed in Example 1E.

FIGS. 6a-6d are SEM micrographs of zinc oxide nanostructures made according to one embodiment of the disclosure and as disclosed in Example 1F.

FIGS. 7a-7d are SEM micrographs of zinc oxide nanostructures made according to one embodiment of the disclosure and as disclosed in Example 1G.

FIGS. 8a-8d are SEM micrographs of zinc oxide nanostructures made according to one embodiment of the disclosure and as disclosed in Example 1H.

FIGS. 9a-9d are SEM micrographs of zinc oxide nanostructures made according to one embodiment of the disclosure and as disclosed in Example 1J.

FIGS. 10a-10d are SEM micrographs of zinc oxide nanostructures made according to one embodiment of the disclosure and as disclosed in Example 1K.

FIGS. 11a-11d are SEM micrographs of zinc oxide nanostructures made according to one embodiment of the disclosure and as disclosed in Example 1L.

FIGS. 12a and 12b are X-ray powder diffraction spectra of zinc oxide electrodes made according to one embodiment of the disclosure and as disclosed in Example 1.

FIG. 13 is X-ray powder diffraction spectra of zinc oxide electrodes made according to one embodiment of the disclosure and as disclosed in Example 1.

FIG. 14 is an electrolytic cell used in a method according to one embodiment of the disclosure, such as that described in Examples 1-4, below.

FIGS. 15a and 15b show the anodic scan of the cyclic voltammetry of a Zn substrate as described in Example 1.

FIGS. 16a and 16b show the anodic scan of the cyclic voltammetry of a Co substrate as described in Example 2.

FIGS. 17a-17d are SEM micrographs of cobalt oxide nanostructures made according to one embodiment of the disclosure and as disclosed in Example 2A.

FIGS. 18a-18d are SEM micrographs of cobalt oxide nanostructures made according to one embodiment of the disclosure and as disclosed in Example 2B.

FIGS. 19a-19d are SEM micrographs of cobalt oxide nanostructures made according to one embodiment of the disclosure and as disclosed in Example 2C.

FIGS. 20a-20d are SEM micrographs of cobalt oxide nanostructures made according to one embodiment of the disclosure and as disclosed in Example 2D.

FIG. 21 is an X-ray powder diffraction spectrum of cobalt oxide on a titanium electrode made according to one embodiment of the disclosure and as disclosed in Example 2E.

FIG. 22 is a graphical representation of current as a function of electrolyte temperature as described in Example 2.

FIGS. 23a-23h are SEM micrographs of zinc oxide nanostructures made according to one embodiment of the disclosure and as disclosed in Example 3A.

FIGS. 24a-24h are SEM micrographs of zinc oxide nanostructures made according to one embodiment of the disclosure and as disclosed in Example 3B.

FIGS. 25a-25h are SEM micrographs of zinc oxide nanostructures made according to one embodiment of the disclosure and as disclosed in Example 3C.

FIGS. 26a-26h are SEM micrographs of zinc oxide nanostructures made according to one embodiment of the disclosure and as disclosed in Example 3D.

FIGS. 27a-27h are SEM micrographs of zinc oxide nanostructures made according to one embodiment of the disclosure and as disclosed in Example 3E.

FIGS. 28a-28h are SEM micrographs of zinc oxide nanostructures made according to one embodiment of the disclosure and as disclosed in Example 3F.

FIGS. 29a-29j are SEM micrographs of zinc oxide nanostructures made according to one embodiment of the disclosure and as disclosed in Example 3G.

FIGS. 30a-30j are SEM micrographs of zinc oxide nanostructures made according to one embodiment of the disclosure and as disclosed in Example 3H.

FIGS. 31a-31j are SEM micrographs of zinc oxide nanostructures made according to one embodiment of the disclosure and as disclosed in Example 3I.

FIGS. 32a-32j are SEM micrographs of zinc oxide nanostructures made according to one embodiment of the disclosure and as disclosed in Example 3J.

FIGS. 33a-33j are SEM micrographs of zinc oxide nanostructures made according to one embodiment of the disclosure and as disclosed in Example 4A.

FIGS. 34a-34j are SEM micrographs of zinc oxide nanostructures made according to one embodiment of the disclosure and as disclosed in Example 4B.

FIGS. 35a-35j are SEM micrographs of zinc oxide nanostructures made according to one embodiment of the disclosure and as disclosed in Example 4C.

FIGS. 36a-36j are SEM micrographs of zinc oxide nanostructures made according to one embodiment of the disclosure and as disclosed in Example 4D.

FIGS. 37a-37j are SEM micrographs of zinc oxide nanostructures made according to one embodiment of the disclosure and as disclosed in Example 4E.

### DETAILED DESCRIPTION

It is to be understood that both the foregoing general description and the following detailed description are exemplary and explanatory only and are not restrictive of the claims. Other embodiments will be apparent to those skilled in the art from consideration of the specification and practice of the embodiments disclosed herein.

The disclosure relates to metal oxide materials with varied nanostructural morphologies and methods for making such materials. More specifically, in various embodiments, the disclosure relates to zinc oxide and cobalt oxide nanostructures of varied morphologies.

As used herein, the term “nanostructures,” and variations thereof, is intended to mean nano-sized particles and includes subnanometer-sized particles as well, i.e., particles that are less than 20 nm. In various embodiments, the nanostructures may be of varied morphology.

As used herein, the term “morphology,” and variations thereof, relates to the structure and/or shape of a given particle.

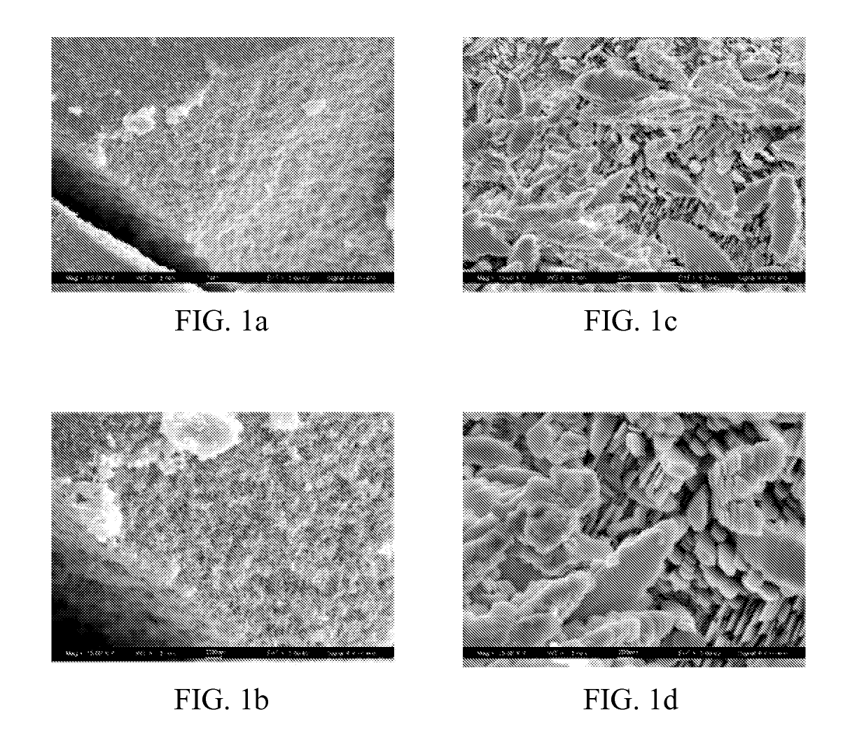

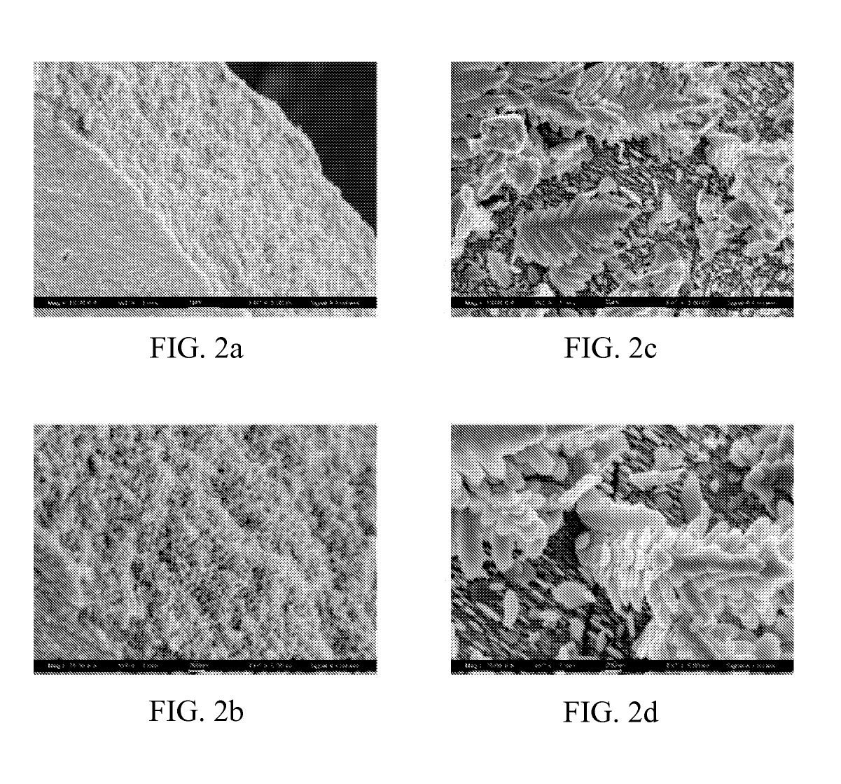

In various embodiments, the disclosure relates to materials comprising zinc oxide nanoparticles in porous network-like structures. As used herein, the phrase “porous network-like structures,” and variations thereof, is intended to include a plurality of nano-sized particles that are at least one of fused and interconnected such that pores are formed around the particles. FIGS. 1a, 1b, 2a, and 2b are SEM micrographs of exemplary porous network-like structures and are further described in Example 1 below, along with other porous network-like structures.

As used herein, the term “pores,” and variations thereof, is intended to mean the voids in the porous network-like structure. In various embodiments of the disclosure, the pores may be circular or irregular. In at least some exemplary embodiments, the diameter of the pores may be 100 nm or less. In further embodiments, the pores may be tunnel-like and may penetrate through the thickness of the structure. The pores are shaped by the walls of the network-like structure, which are comprised of the fused and/or interconnected nanoparticles. In various embodiments, the thickness of the walls of the structure may be 50 nm or less.

In various embodiments, the disclosure also relates to zinc oxide nanostructures having a platelet-like morphology. As used herein, the phrase “platelet-like,” and variations thereof, is intended to include particles having two substantially parallel faces, the distance between which is the shortest distance from the core of the particle. The shape of the faces may be uniform or irregular. FIGS. 1c, 1d, 2c, 2d, and 3b are SEM micrographs of exemplary platelet-like structures and are further described in Example 1 below, along with other platelet-like structures.

In various embodiments, the nanostructures described herein may be aggregated. Non-limiting examples of aggregation include stacking, interpenetration, rosette-like structures, and wooly ball-like structures.

As used herein, the terms “stacking,” “stacked,” and variations thereof, is intended to mean that the nanostructures may be assembled in two or more layers. In the case of platelet-like structures, they may be layered such that their faces are substantially parallel. FIGS. 1c, 1d, 2c, 2d, and 3b are SEM micrographs of exemplary stacked platelet-like structures and are further described in Example 1 below, along with other stacked structures.

As used herein, the term “interpenetrated,” and variations thereof, is intended to mean that the nanostructures may be assembled such that they are intersecting or interconnected. In the case of platelet-like structures, they may be interpenetrated such that their faces are not substantially parallel.

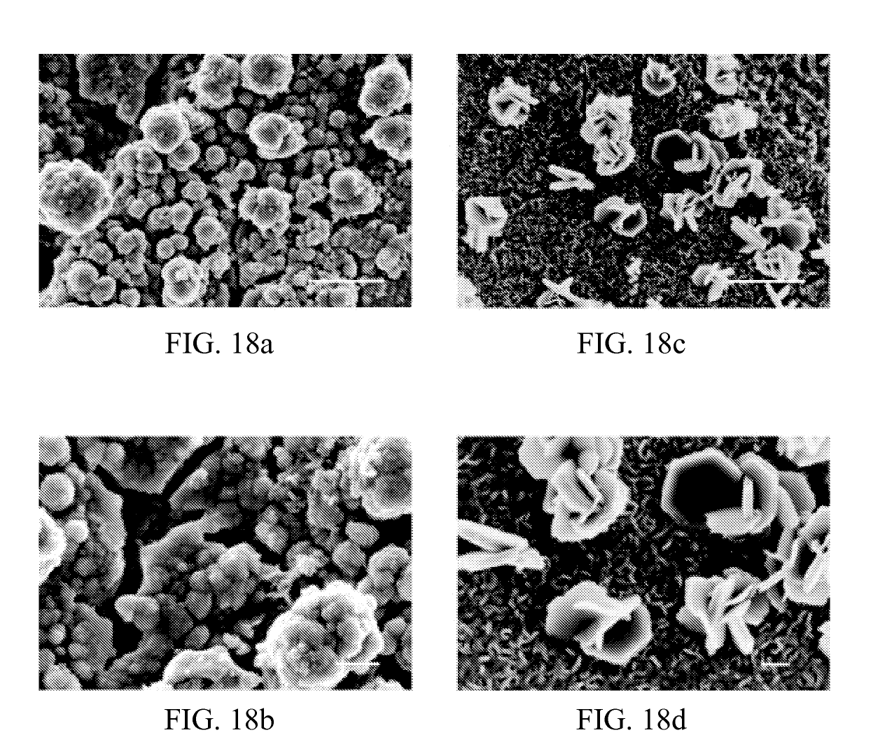

As used herein, the phrase “rosette-like structures” is intended to mean an aggregation of nanostructures radiating from a central point or axis at varying angles. FIGS. 17c, 17d, 18c, and 18d are SEM micrographs of exemplary rosette-like structures and are further described in Example 2 below, along with other rosette-like structures.

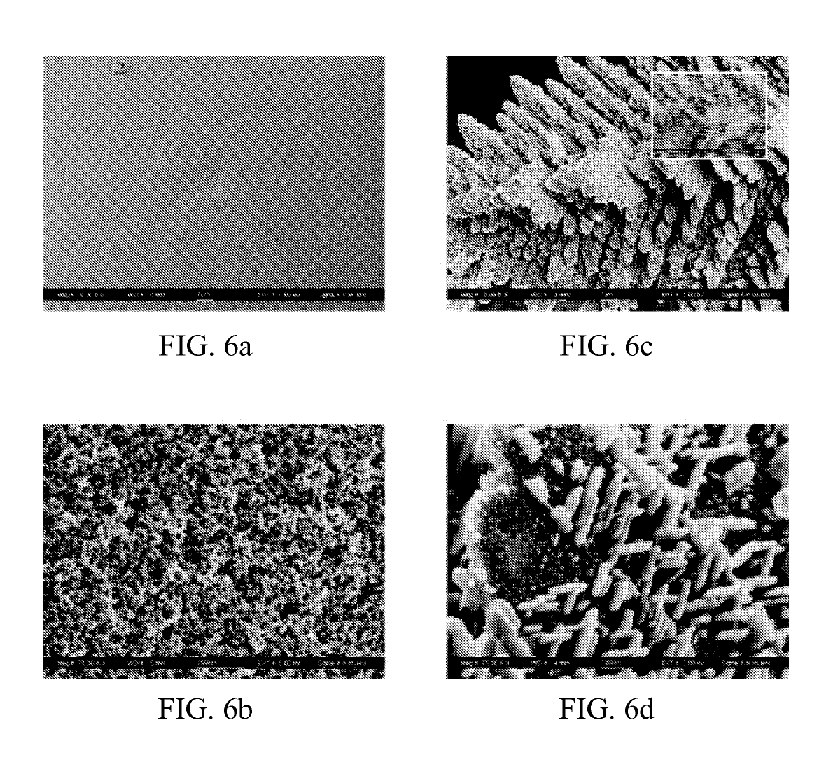

In various embodiments, the disclosure also relates to zinc oxide nanostructures having a leaf-like morphology. As used herein, the phrase “leaf-like,” and variations thereof, is intended to include platelet-like structures wherein the shape of the faces resemble that of leaves, i.e., a spine-like structure with a plurality of branches. FIGS. 6c, 6d, 7c, 7d, 8c, and 8d are SEM micrographs of exemplary leaf-like structures and are further described in Example 1 below, along with other leaf-like structures.

In further embodiments, the leaf-like nanostructures may further comprise secondary features. As used herein, the phrase “secondary features,” and variations thereof, is intended to mean particles or structures on the surface of the base nanostructure and includes, but is not limited to, cross-hatches, rods, grains, and platelets. In various embodiments, the secondary structures may comprise at least one sub-nanometer dimension.

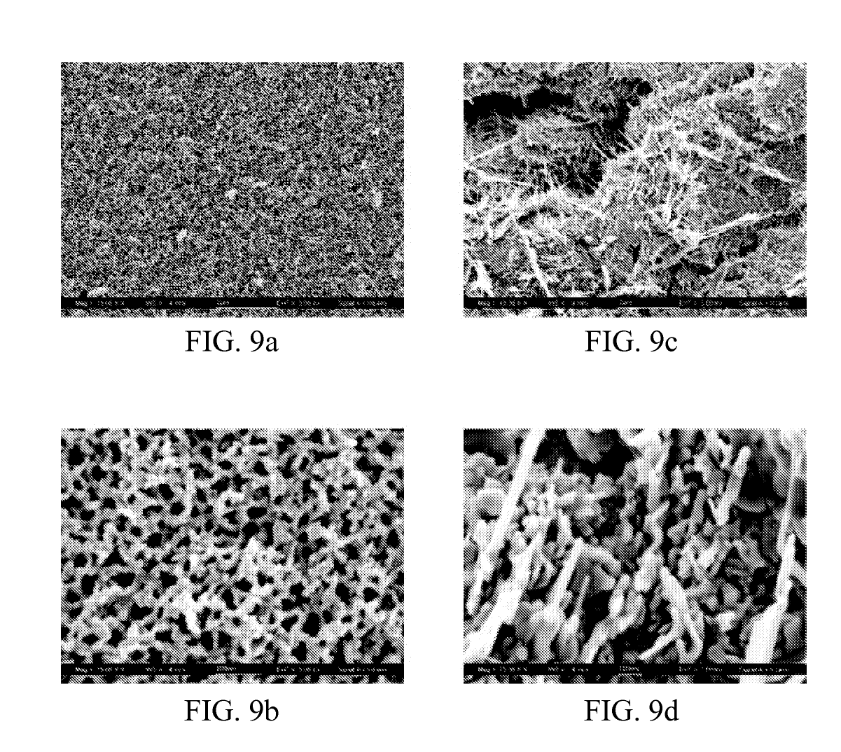

The term “cross-hatches,” as used herein, refers to linear structures, some of which may intersect or cross, wherein the linear aspect of the structures is substantially parallel to the surface of the nanostructure on which they are located. FIGS. 6c, 6d, 9c, and 9d are SEM micrographs of exemplary leaf-like structures further comprising cross-hatch secondary features and are further described in Example 1 below, along with other secondary structures.

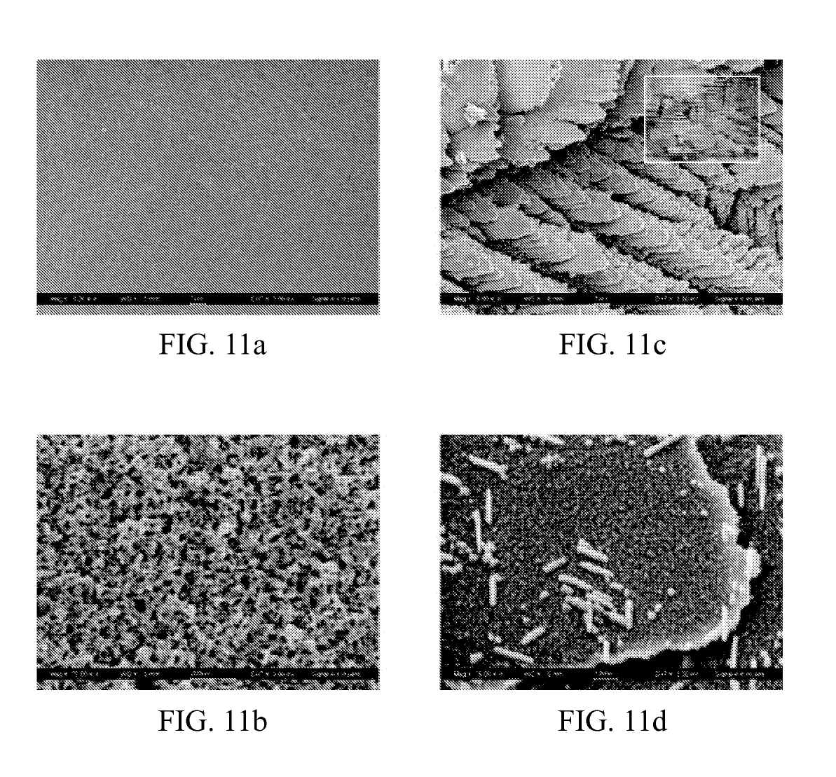

The term “rods,” as used herein, refers to linear structures that may be cylindrically shaped or rod-like and non-hollow. In at least one embodiment, the linear aspect of the rods may be substantially parallel to the surface of the nanostructure on which they are located. In at least one other embodiment, the linear aspect of the rods may be substantially perpendicular to the surface of the nanostructure on which they are located. FIGS. 11c and 11d are SEM micrographs of exemplary leaf-like structures further comprising rods as secondary features and are further described in Example 1 below, along with other secondary structures.

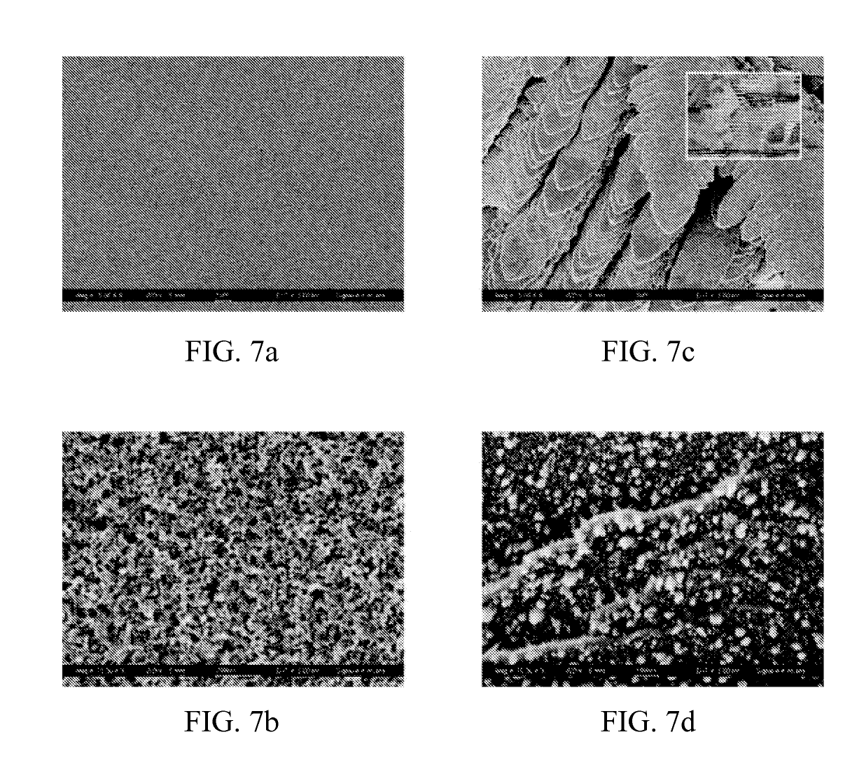

The term “grains,” as used herein, refers to spherical structures or particles. FIGS. 7c, 7d, 11c, and 11d are SEM micrographs of exemplary leaf-like structures further comprising grains as secondary features and are further described in Example 1 below, along with other secondary structures.

The term “platelets,” as used herein with respect to secondary features is intended to have the same meaning as set forth above, i.e., particles having two substantially parallel faces, the distance between which is the shortest distance from the core of the particle. In various embodiments, the platelets of secondary features may have at least one subnanometer dimension.

In various embodiments, the disclosure relates to cobalt oxide nanostructures having a hexagonal platelet-like morphology. As used herein, the phrase “hexagonal platelet-like,” and variations thereof, is intended to include platelet-like structures wherein the shape of the faces may be substantially hexagonal. FIGS. 17c, 17d, 18c, and 18d are SEM micrographs of exemplary hexagonal platelet-like structures and are further described in Example 2 below, along with other hexagonal structures. In further embodiments, the hexagonal platelet-like nanostructures may be aggregated. In at least one embodiment, the aggregated hexagonal platelet-like structures may be stacked. For example, FIGS. 17d, 18d, and 19d are SEM micrographs of exemplary stacked hexagonal platelet-like structures and are further described in Example 2 below, along with other stacked structures.

In at least one embodiment, the aggregated cobalt oxide hexagonal platelet-like nanostructures may form rosette-like structures. For example, FIGS. 17c, 17d, 18c, and 18d are SEM micrographs of exemplary rosette-like structures and are further described in Example 2 below, along with other rosette-like structures.

In various embodiments of the disclosure, the cobalt oxide nanostructures may have a platelet-like morphology. As set forth above, the phrase “platelet-like,” and variations thereof, is intended to include particles having two substantially parallel faces, the distance between which is the shortest distance from the core of the particle. The shape of the faces may be uniform or irregular. In at least one embodiment, the cobalt oxide platelet nanostructure may be irregular. In a further embodiment, the face of the platelets may resemble irregular rectangles, like those in the SEM micrographs of FIGS. 17a and 17b, which are further described in Example 2 below, along with other platelet-like structures. In at least one embodiment, the cobalt oxide platelet nanostructures may be aggregated, including for example stacked and interpenetrating.

In various embodiments, the disclosure relates to cobalt oxide nanostructures having a rod-like morphology. The term “rod-like,” and variations thereof, as used in this regard, means linear structures that may be cylindrically shaped or rod-like and non-hollow. In at least one embodiment, the rod-like cobalt oxide nanostructures may be aggregated, including for example to form woolly ball-like structures. As used herein, the phrase “wooly ball-like,” and variations thereof, is intended to include aggregations of nanostructures that have a generally spherical form with an irregular textured surface with bumps and/or indentations, like a ball of wool. FIGS. 18a, 18b, 19a, 19b, 20a and 20b are SEM micrographs of exemplary rod-like cobalt oxide nanostructures aggregated to form wooly ball-like structures and are further described in Example 2 below, along with other similar structures.

The disclosure also relates to electrochemical methods of making the nanostructures described herein. In various embodiments, the methods comprise providing an electrolytic cell, which comprises an anode and a cathode disposed in an electrolyte comprising a hydroxide, wherein the anode and cathode each comprise a surface exposed to the electrolyte; and applying an electrical potential to the electrolytic cell for a period of time sufficient to obtain nanostructures on the surface of the anode and/or the cathode, when present.

The electrolytic cells of the disclosure may be comprised of any material that is resistive to basic pH and electrically insulating. For example, in various embodiments, the electrolytic cell may be made of polytetrafluoroethylene (PTFE), which is sold commercially under the name Teflon® by DuPont of Wilmington, Del. FIG. 14 depicts an exemplary electrolytic cell 100 for use in the methods disclosed herein.

As exemplified in FIG. 14, the electrolytic cell 100 may comprise an anode 110 and a cathode 112 disposed in an electrolyte 114. In various embodiments, at least the anode comprises a surface 117 exposed to the electrolyte. According to further embodiments, the anode and the cathode may each comprise a surface 116 exposed to the electrolyte as shown in FIG. 14. The nanostructures may be obtained, for example, on the surface of an anode exposed to the electrolyte, on the surface of a cathode exposed to the electrolyte, or on the surface of both an anode and a cathode exposed to the electrolyte.

Reference to “a surface” or “the surface” of an anode or a cathode, and variations thereof, includes one or several surfaces of the anode or the cathode, or both the anode and the cathode, when either is exposed to the electrolyte or having nanostructures obtained thereon.

According to various embodiments, the surface of the anode comprises at least one metal selected from zinc and cobalt. The surface of the anode may further comprise at least one material chosen from metal oxides, mixed metal oxides, additional metals, mixed metals, metal alloys, metal alloy oxides, and combinations thereof.

According to various embodiments, the surface of the cathode, when present, may comprise at least one material selected from metal oxides, mixed metal oxides, metals, mixed metals, metal alloys, metal alloy oxides, and combinations thereof. In further embodiments, the surface of the cathode may comprise at least one metal, and in further embodiments, the at least one metal may be selected from zinc, cobalt, titanium, and combinations thereof.

In at least one embodiment, the anode and cathode may independently comprise at least one material selected from a uniform metal, a metal layer, a metal foil, a metal alloy, multiple metal layers, a mixed metal layer, multiple mixed metal layers and combinations thereof. The layer(s) may be, in various exemplary embodiments, a metal film; a mesh; a patterned layer wherein the metal(s) is/are present in strips, discrete areas, a spot, spots, and combinations thereof. An example of a mixed metal layer is a co-deposited alloy.

In one embodiment, the patterned layer may comprise only one material. In other embodiments, the pattern may comprise more than one material, and the materials may be adjacent (i.e. touching), spaced apart from one another, or any combination thereof. By way of example, a strip of metal could be next to a spot of mixed metal, which could be next to a square of metal alloy, and the strip, spot, and square could be adjacent, could be spaced apart from each other, or some combination thereof.

In another exemplary embodiment comprising layers, layers comprising the same material may be layered on top of each other. In another embodiment, different materials may be layered on top of each other, for example, one metal on top of an alloy, on top of a mixed metal, etc., with any number of combinations possible.

The metal film may be, for example, a thin film or a thick film. The metal film may comprise zinc or cobalt metal. The thin film may range, for example, from a few nanometers in thickness to a few microns in thickness. The thick film may range, for example, from tens of microns in thickness to several hundreds of microns in thickness. The electrical conductivity of the surface of the metal film can facilitate electron transfer at the solid-liquid interface and the electrical connection given to the metal portion of the substrate, i.e., the anode and/or cathode. The substrate may comprise a flat or a non-flat surface. The substrate may be a flexible substrate or a substrate with a deformable surface.

According to various embodiments, the at least one material of the anode and/or cathode may be disposed on a conductive support, a non-conductive support, or a support that has portions that are conductive and portions that are non-conductive. In one embodiment, the anode and the cathode may comprise at least one material selected from cobalt or zinc metal, cobalt or zinc foil, cobalt or zinc film disposed on a conductive support, cobalt or zinc film disposed on a non-conductive support, and combinations thereof.

Conductive supports may, for example, comprise at least one material selected from metals, metal alloys, nickel, stainless steel, indium tin oxide (ITO), copper, and combinations thereof. In various embodiments, the conductive support may be any conductive metallic substrate.

Non-conductive supports may, for example, comprise at least one material selected from polymers, plastic, glass, and combinations thereof.

The methods of the disclosure may further comprise cleaning the substrates prior to contacting the electrolyte.

The electrolyte of the disclosure comprises at least one hydroxide. For example, the electrolyte may be a solution comprising sodium hydroxide, potassium hydroxide, and combinations thereof. The solution, in some embodiments, may be at a concentration ranging from 1 molar to 10 molar, such as, for example, ranging from 3 molar to 8 molar, for example, 5 molar.

In various embodiments, the electrolyte may further comprise at least one additive. As used herein, the term “at least one additive” includes, but is not limited materials that may modify the chemical and/or physical properties of a nanostructure. Non-limiting examples of at least one additive include boric acid, phosphoric acid, carbonic acid, sodium sulfate, potassium sulfate, sodium sulfite, potassium sulfite, sodium sulfide, potassium sulfide, sodium phosphate, potassium phosphate, sodium nitrate, potassium nitrate, sodium nitrite, potassium nitrite, sodium carbonate, potassium carbonate, sodium bicarbonate, potassium bicarbonate, a sodium halide, a potassium halide, a surfactant, and combinations thereof. When the at least one additive is a surfactant, it may be ionic, nonionic, biological, and combinations thereof.

Exemplary ionic surfactants include, but are not limited to, (1) anionic (based on sulfate, sulfonate or carboxylate anions), for example, perfluorooctanoate (PFOA or PFO), perfluorooctanesulfonate (PFOS), sodium dodecyl sulfate (SDS), ammonium lauryl sulfate, and other alkyl sulfate salts, sodium laureth sulfate (also known as sodium lauryl ether sulfate (SLES)), alkyl benzene sulfonate, soaps, and fatty acid salts; (2) cationic (based on quaternary ammonium cations), for example, cetyl trimethylammonium bromide (CTAB) (also known as hexadecyl trimethyl ammonium bromide), and other alkyltrimethylammonium salts, cetylpyridinium chloride (CPC), polyethoxylated tallow amine (POEA), benzalkonium chloride (BAC), and benzethonium chloride (BZT); and (3) zwitterionic (amphoteric), for example, dodecyl betaine, cocamidopropyl betaine, and coco ampho glycinate.

Exemplary nonionic surfactants include, but are not limited to, alkyl poly(ethylene oxide), alkylphenol poly(ethylene oxide), copolymers of poly(ethylene oxide) and poly(propylene oxide) (commercially known as Poloxamers or Poloxamines), alkyl polyglucosides, for example, octyl glucoside and decyl maltoside, fatty alcohols, for example, cetyl alcohol and oleyl alcohol, cocamide MEA, cocamide DEA, and polysorbates (commercially known as Tween 20, Tween 80), for example, dodecyl dimethylamine oxide.

Exemplary biological surfactants include, but are not limited to, micellular-forming surfactants or surfactants that form micelles in solution, for example, DNA, vesicles, and combinations thereof.

By incorporating at least one surfactant in the electrolyte, the nanostructures may become ordered, for example, by self-assembly.

In various embodiments, the electrolyte may further comprise at least one additional additive. As used herein, the term “at least one additional additive” includes, but is not limited to, a borate, a phosphate, a carbonate, a boride, a phosphide, a carbide, an intercalated alkali metal, an intercalated alkali earth metal, an intercalated hydrogen, a sulfide, a nitride, and combinations thereof. The composition of the nanostructures may, in some embodiments, be dependent on the selection of the at least one additional additive.

In various embodiments of the disclosure, the methods of making metal oxide nanostructures comprise exposing the anode and optionally cathode surfaces to the electrolyte, and applying an electrical potential to the electrolytic cell for a period of time sufficient to obtain nanostructures on the anode and/or cathode surface exposed to the electrolyte.

As shown in FIG. 14, the electrical potential may be applied via a power supply 118, for example, a direct current (DC) power supply, which can supply a constant voltage, or a bipotentiostat, which can supply a cyclic voltage. The potential is not limited to a cyclic voltage, for example, any potential program can be used according to the method. A triangular wave, a pulsed wave, a sine wave, a staircase potential, or a saw-tooth wave are exemplary potential programs. Other applicable potential programs could be used such as other potential programs known by those skilled in the art. In various embodiments, the potential is greater than 0.0 volts, such as 0.5 volts or more. In other embodiments, the potential may be 5.0 volts or less, for example, in the range of from 0.6 volts to 5.0 volts, such as 3.0 volts. The potential, according to various embodiments, may be applied for a period of time of 1 minute or more. The potential, according to other embodiments may be applied for a period of time of 24 hours or less. By way of example, the potential may be applied for a period of time ranging from 30 minutes to 24 hours, for example, for 4 hours to 18 hours, such as 30 minutes, 2 hours, or 6 hours.

One or more nanostructures may be obtained by the methods described herein. By way of example, when a surface exposed to the electrolyte comprises a metal, a mixed metal, and/or a metal alloy, the metal or metals could be converted to an oxide or a hydroxide, or could remain a metal. For example, all of the metals, one or more of the metals, or none of the metals could be converted to an oxide or hydroxide, or any combination thereof. In various embodiments, at least one metal is converted to an oxide. In a further embodiment, the at least one metal may be chosen from zinc and cobalt, and the oxide formed may be zinc oxide or cobalt oxide, respectively. Conversion of the metal(s) to an oxide or a hydroxide may be dependent upon the specific starting material, for example, dependent upon the material's electrochemical behavior when exposed to the electrolyte.

In further exemplary embodiments, when a surface exposed to the electrolyte comprises a metal oxide, a mixed metal oxide, or a metal alloy oxide, the metal oxide may be converted to a metal or a hydroxide. Conversion of the metal oxides to a metal or a hydroxide may be dependent upon the specific starting material, for example, dependent upon the material's electrochemical behavior when exposed to the electrolyte. In further embodiments, the metal oxides may remain oxides but the stoichiometry may change. For example, in the case of cobalt oxide, when a surface comprises CoO, after electrochemical processing the composition of the nanostructures can remain CoO, can be converted to CO₃O₄, can be converted to Co, or combinations thereof.

The nanostructures obtained by the methods described herein may have one or more particle structure or morphology. By way of example, the zinc oxide nanostructures of the disclosure may comprise porous network-like structures, platelet-like morphology, and leaf-like morphology. In various embodiments, the platelet-like and/or leaf-like structures may be aggregated. In at least one embodiment, the aggregated nanostructures may be stacked or interpenetrating. In various embodiments, the leaf-like structures may further comprise secondary structures, which include cross-hatch structures, rods, and grains.

As further examples, the cobalt oxide nanostructures of the disclosure may comprise platelet-like morphology and hexagonal platelet-like morphology. In various embodiments, cobalt oxide structures may be aggregated. In at least one embodiment, the aggregated nanostructures may be stacked, interpenetrating, or form rosette-like structures.

In various embodiments, the methods described herein may be carried out at ambient conditions, for example, room temperature and atmospheric pressure, and may utilize low voltage and current, thus, lower energy. In other embodiments, the method may further comprise heating the electrolyte to a temperature of from 15° C. to 80° C., for example, from 30° C. to 80° C., for example, from 30° C. to 60° C., such as 40° C. or 60° C. Heating the electrolyte may be accomplished by a number of heating methods known in the art, for example, a hot plate placed under the electrolytic cell. In various embodiments, the temperature may be adjusted depending on desired nanostructures and materials used. Appropriate heating temperature, if any, is within the ability of those skilled in the art to determine.

In one embodiment, the method may further comprise agitating the electrolyte. Any number of agitation methods known in the art may be used to agitate the electrolyte, for example, a magnetic stirring bar placed in the electrolyte with a stirrer placed under the electrolytic cell. Mechanical stirring or ultrasonic agitation, for example, may also be used. Appropriate conditions (e.g. stirring rate) for agitation, if any, are within the ability of those skilled in the art to determine.

According to one embodiment, the method may further comprise cleaning the anode and/or the cathode after obtaining the nanostructures. The cleaning, in some embodiments, may comprise acid washing. The acid may be selected from hydrochloric, sulfuric, nitric, and combinations thereof.

In one embodiment, the method comprises making the nanostructures in a batch process. In another embodiment, the method comprises making the nanostructures in a continuous process.

For example, in various embodiments, the process may be a batch process where sheets of zinc or cobalt substrates may be immersed in the electrolyte (such as NaOH or KOH) and nanostructures created by applying an electric potential.

Other exemplary embodiments may include a continuous process wherein two zinc or cobalt substrate rolls are fed (e.g. continuously) into a tank containing electrolyte (such as NaOH or KOH) while electric potential is being applied. A downstream cleaning and/or rinsing step may optionally be integrated producing rolls of zinc or cobalt oxide nanostructured surfaces.

In various embodiments described herein, the reaction may be limited to the surface that is in contact with the electrolyte, allowing for improved or otherwise satisfactory process control.

In various embodiments, the process may be monitored by monitoring the current as a function of time.

Unless otherwise indicated, all numbers used in the specification and claims are to be understood as being modified in all instances by the term “about,” whether or not so stated. It should also be understood that the precise numerical values used in the specification and claims form additional embodiments of the invention. Efforts have been made to ensure the accuracy of the numerical values disclosed in the Examples. Any measured numerical value, however, can inherently contain certain errors resulting from the standard deviation found in its respective measuring technique.

As used herein the use of “the,” “a,” or “an” means “at least one,” and should not be limited to “only one” unless explicitly indicated to the contrary. Thus, for example, the use of “the nanostructure” or “nanostructure” is intended to mean at least one nanostructure.

Other embodiments of the invention will be apparent to those skilled in the art from consideration of the specification and practice of the invention disclosed herein. It is intended that the specification and examples be considered as exemplary only, with a true scope and spirit of the invention being indicated by the claims.

### EXAMPLES

### Example 1

99.98% zinc foils of 0.25 nm and 1.6 nm thicknesses, available from Alfa Aesar of Ward Hill, Mass., were cut to size and cleaned by sonication in a 1:1:1 mixture of acetone, iso-propanol, and deionized (DI) water for 15 minutes. The zinc foils were then rinsed in DI water and further sonicated in DI water for 15 minutes. The zinc foils were dried under a stream of nitrogen.

The electrolyte was prepared using certified ACS sodium hydroxide and certified ACS potassium hydroxide, all available from Alfa Aesar, in DI water.

Electrolytic cells, for example, electrochemical cells of different sizes (1.5″×1″×1″ and 6″×3″×7″ internal dimensions) were made using Teflon.

A bipotentiostat, model AFRDE5, available from PINE Instrument Company of Grove City, Pa., was used to perform cyclic voltammetry methods. Constant voltage methods were performed using a DC power supply, Model E36319, available from Agilent of Santa Clara, Calif. In the examples, similarly sized zinc foils were used as both the anode and the cathode surfaces.

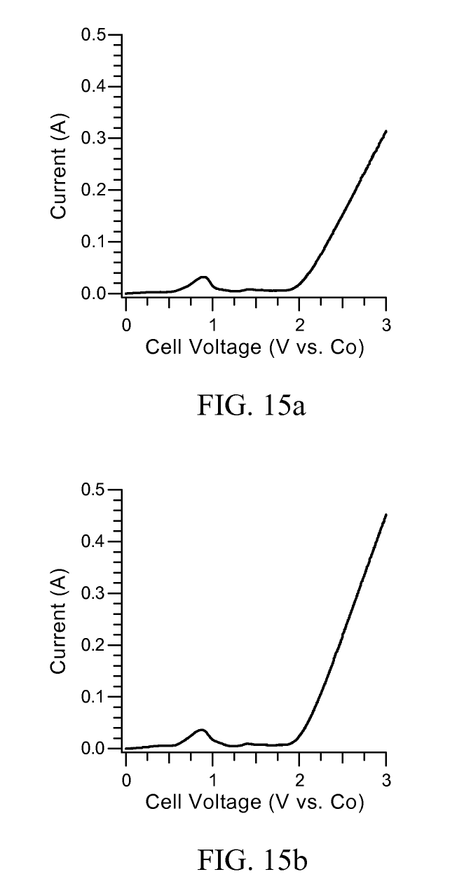

FIGS. 15a and 15b show the anodic scan of the cyclic voltammetry of a Zn substrate in 10 molar (M) NaOH and 1M KOH electrolytes, respectively.

As shown in FIG. 15a, at potentials less than 0.37 volts (V) in the NaOH electrolyte, small current is observed. This may be indicative of partial oxidation of the Zn surface. As the potential is increased beyond 0.37V, a large anodic current is observed with increasing potential values. The current increases continuously until a potential of 2.6V, at which point the current starts to drop.

At about 2.75V, a subsequent electron-transfer reaction is initiated as indicted by the increase in current with voltage.

FIG. 15b shows the cyclic voltammetry of a Zn substrate in 1M KOH. The Zn electrode exhibits similar (but not identical) behavior to the NaOH electrolyte (FIG. 15a). At potentials less than 0.4V, small oxidation currents can be observed, with a minor peak at ˜0.1V. The substrate current increases continuously beyond 0.4V until a potential of 2.4V, at which point it drops. At a potential of 2.7V, a subsequent electron-transfer reaction is initiated as indicated by the increase in current.

The cyclic voltammetry may be used as a guide for predictive experimentation, i.e. the potential to be applied can be chosen to influence reaction-specific changes to the surface of the anode and/or the cathode. Based on the cyclic voltammetry of the Zn electrodes, it was decided to run the experiments at a voltage of 3V, which was believed to correspond to carrying out the first oxidation reaction at a diffusion-limited rate.

The experimental set up shown in FIG. 14 was used, and pre-cleaned Zn foils (anodes and cathodes) were placed vertically against opposing faces of a Teflon® cell and immersed in an electrolyte (NaOH or KOH). A magnetic stir bar was used to stir the solution. The foils were then connected to a DC power supply, which applied a preset voltage across the two foils, now electrodes. After subjecting the foils/electrodes to the electrochemical potential, the anode and cathode electrodes were acid washed in 1M HCl to remove any NaOH or KOH left behind by the electrochemical experiments. Several examples were performed by systematically changing various experimental conditions. The results are discussed below.

### Example 1A

FIGS. 1a-1d show the scanning electron microscope (SEM) micrographs of zinc foils/electrodes that were subjected to an electrochemical potential of 3V for 30 minutes in a solution containing 5M NaOH. A highly porous structure formed on the anode. FIGS. 1a and 1b show the top surface and a view of the cross section of a cracked edge of the anode at magnifications of 10,000× and 25,000× respectively. It is clear that the porous network-like structures penetrate through the thickness of the electrode and are not present just on the surface. This aspect demonstrates accessibility of the pores to liquids (and gases), which may result in high mass-transfer rates of fluid in practical applications.

FIGS. 1c and 1d, which were taken at magnifications of 10,000× and 25,000× respectively, show the distinctly different nanostructures that can be observed on the cathode. These structures are platelet-like in their morphology, and include stacked platelet-like structures, as clearly seen in FIG. 1d.

### Example 1B

Next, the electrolyte concentration was changed. FIGS. 2a-2d depict the SEM images of zinc foils that were subjected to a potential of 3V for 30 minutes in a solution containing 10M NaOH. FIGS. 2a and 2c were taken at magnifications of 10,000×, and FIGS. 2b and 2d were taken at magnifications of 25,000×. The structures obtained on both the anode and cathode are similar to those obtained in 5M NaOH electrolyte. Images of the anode, FIGS. 2a and 2b, show that the porous network-like structure penetrates several microns into the electrode or foil as evident from the cross sectional images.

### Example 1C

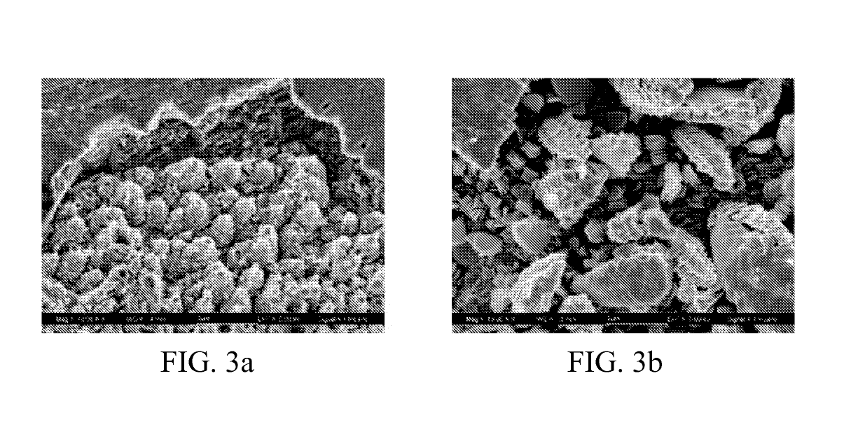

In the next case, the electrolyte was changed from NaOH to KOH. FIGS. 3a and 3b show the SEM images of Zn foils that were subjected to 3V for 30 minutes in a solution containing 5M KOH. No discernible structures were observed on the anode, as shown in FIG. 3a (at a magnification of 10,000×). A non-uniform surface roughening was observed but with no apparent micro- or nano-structures. On the cathode, FIG. 3b (also at a magnification of 10,000×), stacked platelet-like structures similar to those observed for NaOH electrolytes in Examples 1A and 1B can be observed.

### Example 1D

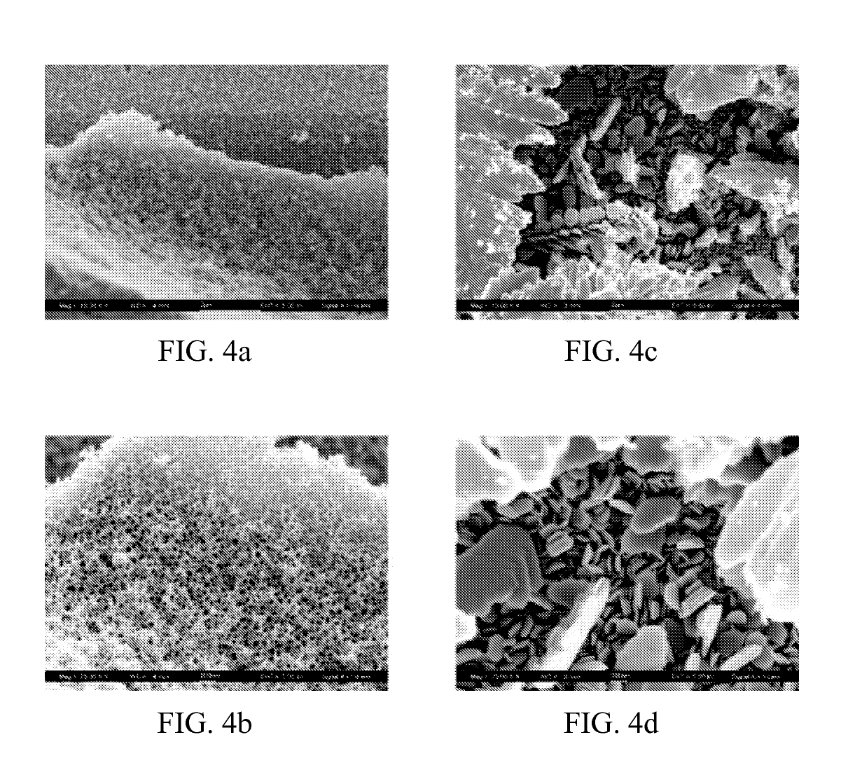

Next the electrolyte (KOH) concentration was increased from 5M, as in Example 1C, to 10M. FIGS. 4a-4d show the SEM images of Zn foils that were subjected to 3V for 30 minutes in a solution containing 10M KOH, and nanostructures are now observed on both the anode and the cathode. The anode, depicted in FIGS. 4a and 4b at magnifications of 10,000× and 25,000× respectively, shows a porous structure as in Examples 1A and 1 B. The cathode, depicted in FIGS. 4c and 4d at magnifications of 10,000× and 25,000× respectively, shows platelet structures with the thickness of the platelets slightly greater than the previous cases.

The formation of nanostructures, particularly on the anode, with increasing electrolyte concentration suggests that a higher rate of reaction or a longer reaction time may be needed for the formation of the nanostructures. The effect of increasing reaction time at an electrolyte concentration of 5M was studied next.

### Example 1E

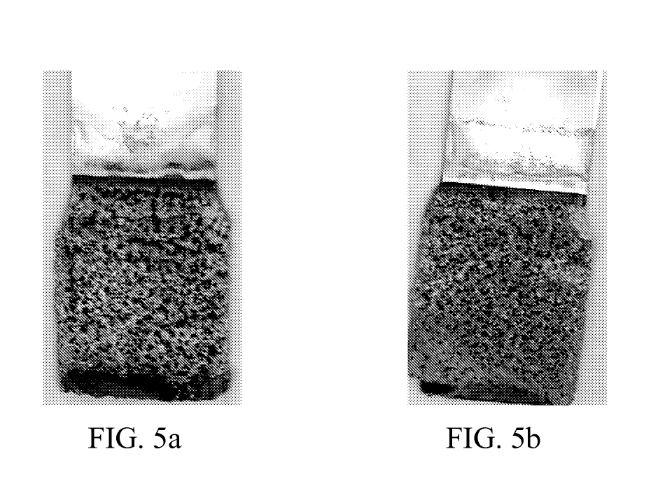

The zinc foils were next subjected to a potential of 3V in NaOH and KOH electrolytes for 2 hours. At the end of the electrochemical experiments, “foamy” structures could be observed visually on the cathodes as seen in the optical images of FIGS. 5a and 5b, respectively. On the other hand, the anode surfaces seemed to have lost material from the surface. Nevertheless, structures were still observed on the anodes.

### Example 1F

FIGS. 6a-6d shows the SEM micrographs of Zn foils subjected to a potential of 3V for 2 hours in 5M NaOH. FIGS. 6a and 6b show a porous network-like structure on the anode at magnifications of 5,000× and 75,000×, respectively, but the pores appear less open compared to the 30 minute sample of Example 1A. The pore walls seem to have collapsed to a certain extent forming a sea of nanoparticles of sub-15 nm sizes but still having liquid/gas access through the thickness of the sample. FIGS. 6c and 6d show leaf-like structures on the cathode at magnifications of 5,000× and 75,000×, respectively. The individual “leaflettes” are few nanometers thick and further comprise sub-nanometer sized features on their surfaces, as is evident from FIG. 6d, which shows cross-hatches as secondary features.

### Example 1G

FIGS. 7a-7d show the SEM micrographs of Zn foils subjected to a potential of 3V for 2 hours in 5M KOH. The structures on anode and cathode are similar to Example 1F, with minor differences in the cathode nanostructures. FIGS. 7a and 7b show a porous network-like structure on the anode at magnifications of 5,000× and 75,000×, respectively. FIGS. 7c and 7d show more leaf-like structures on the cathode at magnifications of 5,000× and 75,000×, respectively. In this case, the features on the platelet surfaces are grains, as is evident from FIG. 7d.

### Example 1H

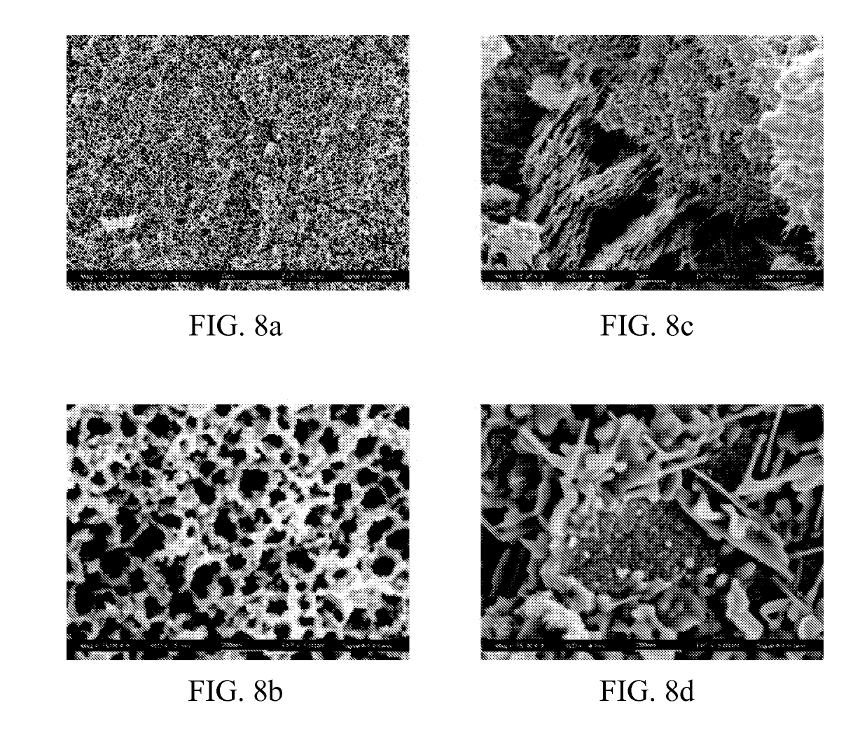

The effect of heat treatment on the nanostructures was also studied. FIGS. 8a-8d show the SEM images of Zn foils subjected to a potential of 3V for 2 hours in 5M NaOH, followed by acid wash and subsequent heat treatment. The anode and cathode foils/substrates were heated to 500° C. at a rate of 10° C./min and held at 500° C. for 1 hour. FIGS. 8a and 8b show, at magnifications of 10,000× and 75,000× respectively, that the pores on the anode seem to have opened up with heat treatment and the walls of the pores consist of interconnected spherical nanoparticles, almost web-like. On the other hand, FIGS. 8c and 8d show, at magnifications of 10,000× and 75,000× respectively, that the platelet structures of the cathode become spongy with secondary nanometer-sized needle structures.

### Example 1J

The procedure of Example 1H was repeated using KOH as the electrolyte. The images of FIGS. 9a-9d were collected in a corresponding manner and exhibit similar structures.

### Example 1K

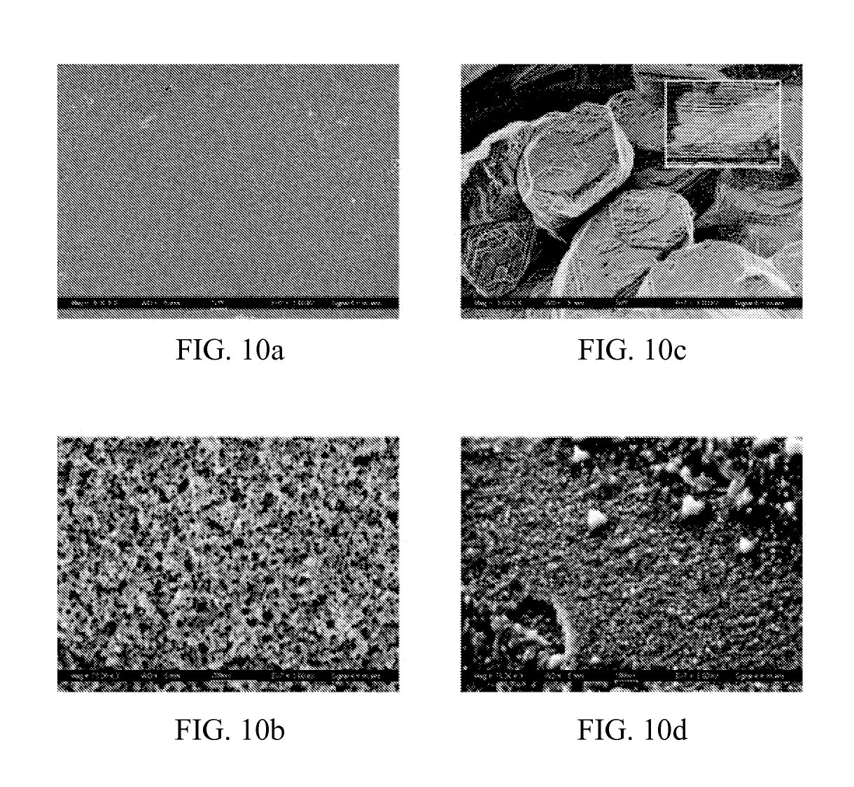

FIGS. 10a-10d show the SEM micrographs of Zn foils subjected to a potential of 3V for 6 hours in 5M NaOH. The anode exhibits structures similar to the anodes of Examples 1A and 1F, as seen in FIGS. 10a and 10b, with magnifications of 5,000× and 75,000×, respectively. FIGS. 10c and 10d, with magnifications of 5,000× and 75,000×, respectively, show cathode platelet microstructures with nanometer sized surface roughness.

### Example 1L

FIGS. 11a-11d show the SEM micrographs of Zn foils subjected to a potential of 3V for 6 hours in 5M KOH. The anode and cathode exhibit structures similar to the anodes and cathodes of Examples 1B and 1G. FIGS. 11a and 11b, with magnifications of 5,000× and 75,000×, respectively, show the structures for the anode, and FIGS. 11c and 11d, with magnifications of 5,000× and 75,000×, respectively, show the structures for the cathode. In the case of the cathode, the secondary structures are rods and grains, as seen in FIG. 11d.

It is apparent from the results of the Example 1 structures that one could tune the experimental conditions to obtain desired nanostructures. For example, if porous structures are desired (similar to the ones observed in the anodes of Example 1), a shorter experimental time, for example less than 30 minutes, may be desirable so that excessive material is not stripped from the anode. Similarly, if the leaf-like zinc oxide structures are desired, sacrificial anodes could be used. It should be noted that any conductive substrate may act as the cathode to collect the nanomaterial, for example, zinc oxide in this case.

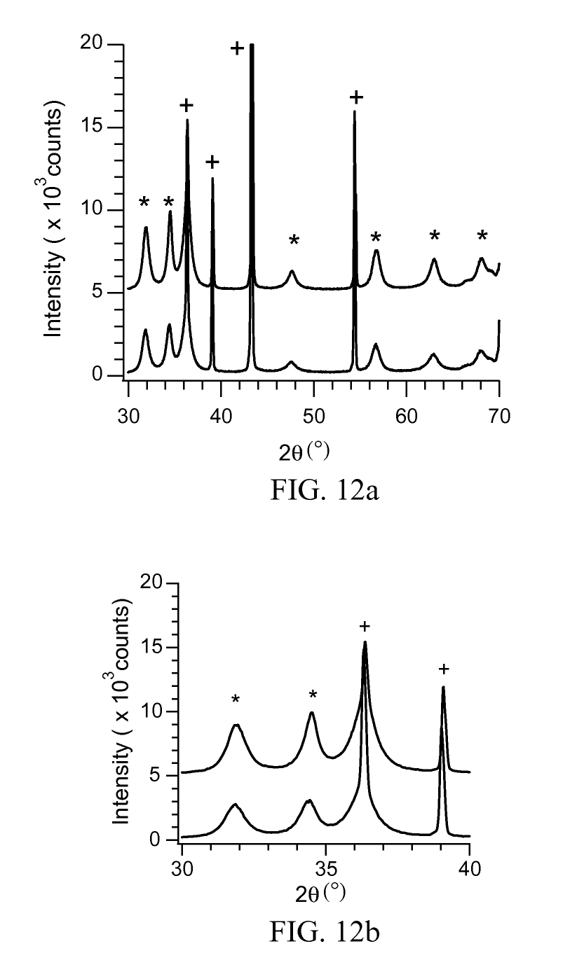

FIG. 12 shows the X-ray diffraction (XRD) spectra of the anode surfaces in the electrochemical experiments in NaOH and KOH electrolytes, as set forth in Examples 1F and 1G. The curves in FIG. 12 are offset for clarity, with the lower curve corresponding to NaOH, and the upper curve corresponding to KOH. The electrodes were acid washed prior to XRD analysis. The data indicates the presence of hexagonal zinc oxide (Wurtzite), which is noted by “*”, in both the electrolytes, along with the background from the Zn substrate, noted by “+”. The broad diffraction peaks (inset in FIG. 12) of ZnO may indicate very fine crystallite size in the range of 10-15 nm.

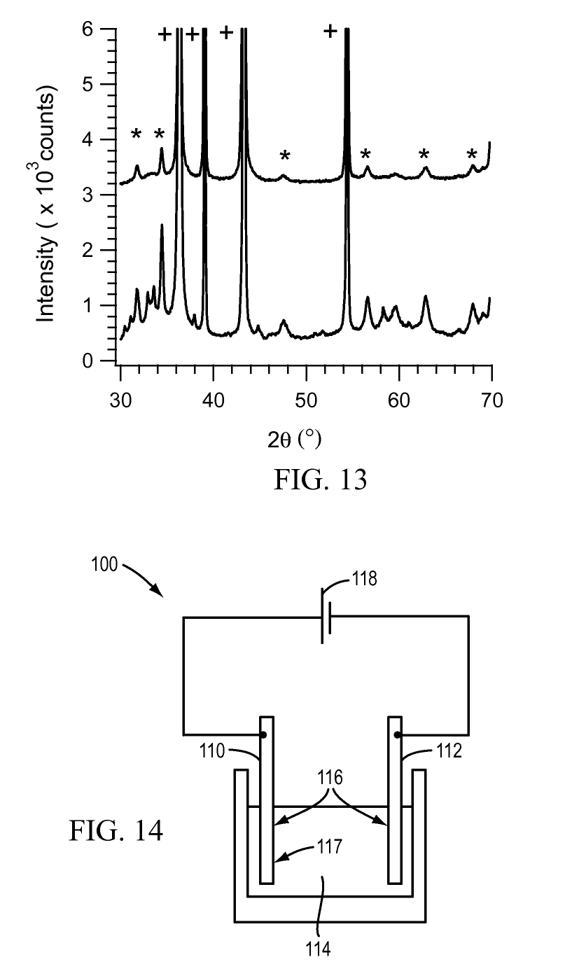

FIG. 13 shows the powder XRD analysis performed on the acid washed powders obtained from the cathodes in the electrochemical experiments in NaOH and KOH electrolytes, as set forth in Examples 1F and 1G. The curves in FIG. 13 are offset for clarity, with the lower curve corresponding to NaOH, and the upper curve corresponding to KOH. The data indicated the presence of both Zn and hexagonal zinc oxide (ZnO) in both the electrolytes, also noted by “+” and “*” respectively. Additionally, minor XRD peaks corresponding to Simonkolleite (Zn₅(OH)₈Cl₂.H₂O) and zinc chlorate (Zn(ClO₄)₂) were also observed. It is hypothesized that the chlorine ions might have been introduced during the acid wash step to the oxide material forming these minor phases. This could be eliminated by controlling the processing parameters during the acid wash step, for example the concentration of HCl, time, series of acid-wash steps with intermittent DI water wash, etc.

### Example 2

99.95% cobalt foils (0.25 mm thick) available from Alfa Aesar of Ward Hill, Mass., were cut to size and cleaned by sonication in a 1:1:1 mixture of acetone, iso-propanol, and deionized (DI) water for 15 minutes. The cobalt foils were then rinsed in DI water and further sonicated in DI water for 15 minutes. The cobalt foils were dried under a stream of nitrogen.

The electrolyte was prepared using certified ACS sodium hydroxide and certified ACS potassium hydroxide, all available from Alfa Aesar, in DI water.

Electrolytic cells, for example, electrochemical cells of different sizes (1.5″×1″×1″ internal dimensions) were made using Teflon. Teflon was chosen because Teflon is stable in basic environment as opposed to glass or metal vessels that can be susceptible to etching and/or corrosion effects.

A bipotentiostat, model AFRDE5, available from PINE Instrument Company of Grove City, Pa., was used to perform cyclic voltammetry methods. Constant voltage methods were performed using a DC power supply, Model E36319, available from Agilent of Santa Clara, Calif. In the examples, similarly cobalt substrates were used as both the anode and the cathode surfaces, unless otherwise noted. 99.5% titanium foil available from Alfa Aesar (annealed and 0.25 mm thick) was used as the counter electrode to collect cobalt oxide nanomaterial for the determination of composition using XRD, which is set forth below.

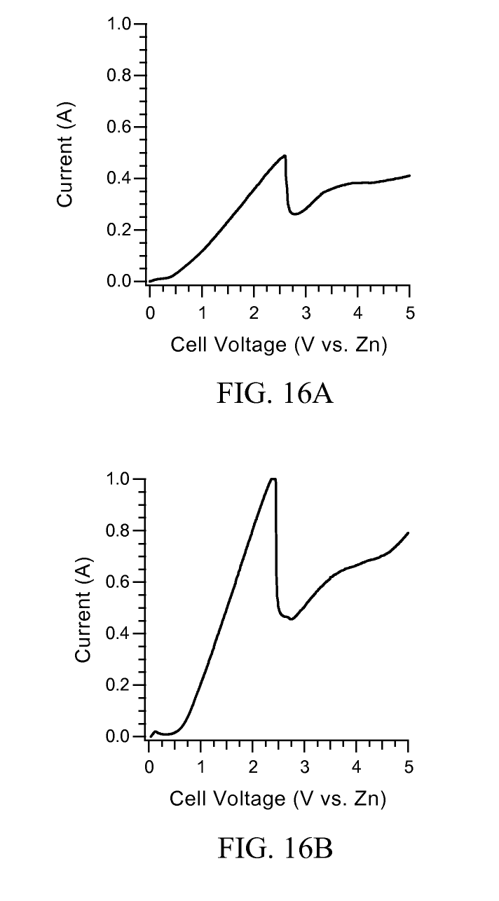

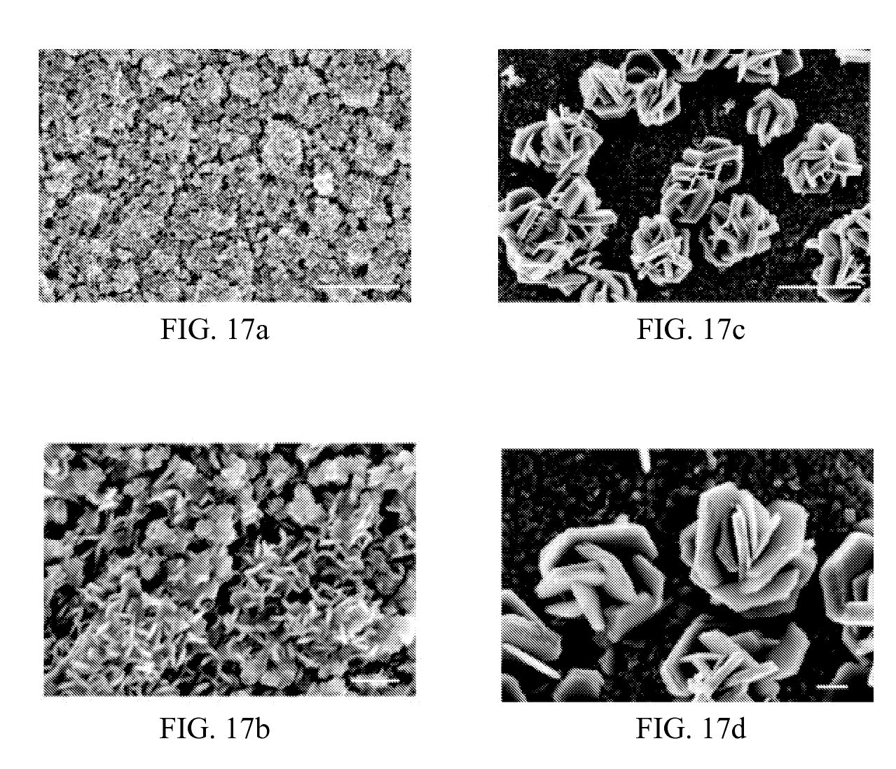

FIGS. 16a and 16b show the anodic scan of the cyclic voltammetry of a Co substrate in 5M NaOH and 5M KOH electrolytes, respectively.

As shown in FIG. 16a, at potentials less than 0.5V in the NaOH electrolyte, little or no current is observed. This may be indicative of the absence of any Faradaic (electron transfer) reactions. As the potential is increases beyond 0.5V, the magnitude of the anodic current increases with potential until it peaks at ˜0.9V. It may be hypothesized that this peak is indicative of self-limitation of the electron transfer reaction at potentials less than 0.9V. Then the potential declines and remains relatively flat until 1.9V, after which it increases continuously.

FIG. 16b shows the cyclic voltammetry of a Co substrate in 5M KOH. The Co electrode exhibits almost identical behavior to the NaOH electrolyte (FIG. 16a).

Based on the cyclic voltammetry of the Co electrodes, it was decided to run the experiments at a voltage of 3V, and the electrolyte concentration used was 5M, which eliminates any mass transport limitation during experimentation.

The experimental set up shown in FIG. 14 was used, and precleaned Co foils/substrates (anodes and cathodes) were placed vertically against opposing faces of a Teflon® cell, and then the cell was filled with an electrolyte (NaOH or KOH). The foils were then connected to a DC power supply, which applied a preset voltage across the two foils, now electrodes. After subjecting the foils/electrodes to the electrochemical potential, the anode and cathode electrodes were acid washed in 1M HCl to remove any NaOH or KOH left behind by the electrochemical experiments. Several examples were performed by systematically changing various experimental conditions. The results are discussed below.

First, a control sample comprising Co was immersed in 5M NaOH electrolyte for 2 hours at room temperature. No new structure was introduced after the control treatment.

### Example 2A

FIGS. 17a-17d show the scanning electron microscope (SEM) micrographs of cobalt foils/electrodes that were subjected to an electrochemical potential of 3V for 2 hours in an electrolyte containing 5M NaOH that was maintained at a constant temperature of 40° C. Structures with nanometer sized features can clearly be observed both on the anode and the cathode. FIGS. 17a and 17b show two distinct structures can be seen on the anode at magnifications of 25,000× and 75,000×, respectively: i) spherical/near-spherical “lumpy” particles with high surface roughness, which are rod-like nanostructures aggregated to form wooly ball-like structures, and ii) platelets, some of which appear rectangular in shape and some of which appear interpenetrating. FIGS. 17c and 17d show the formation of hexagonal platelets on the cathode at 25,000× and 50,000× magnification. The hexagonal platelets are further assembled in rosettes. Additionally, it can be seen in FIG. 17d that the hexagonal platelets are stacked as well.

### Example 2B

FIGS. 18a-18d show the scanning electron microscope (SEM) micrographs of cobalt foils/electrodes that were subjected to an electrochemical potential of 3V for 2 hours in an electrolyte containing 5M KOH that was maintained at a constant temperature of 40° C. FIGS. 18a and 18b show the formation of cobalt oxide nanostructures on the anode at magnifications of 25,000× and 75,000×, respectively. These particles are rod-like nanostructures aggregated to form wooly ball-like structures. FIGS. 18c and 18d show the formation of hexagonal platelets assembled in rosettes on the cathode at 25,000× and 50,000× magnification. These structures resemble those of Example 2A FIGS. 18c and 18d also show smaller, sub-20 nm, interpenetrating flat chip-like features.

### Example 2C

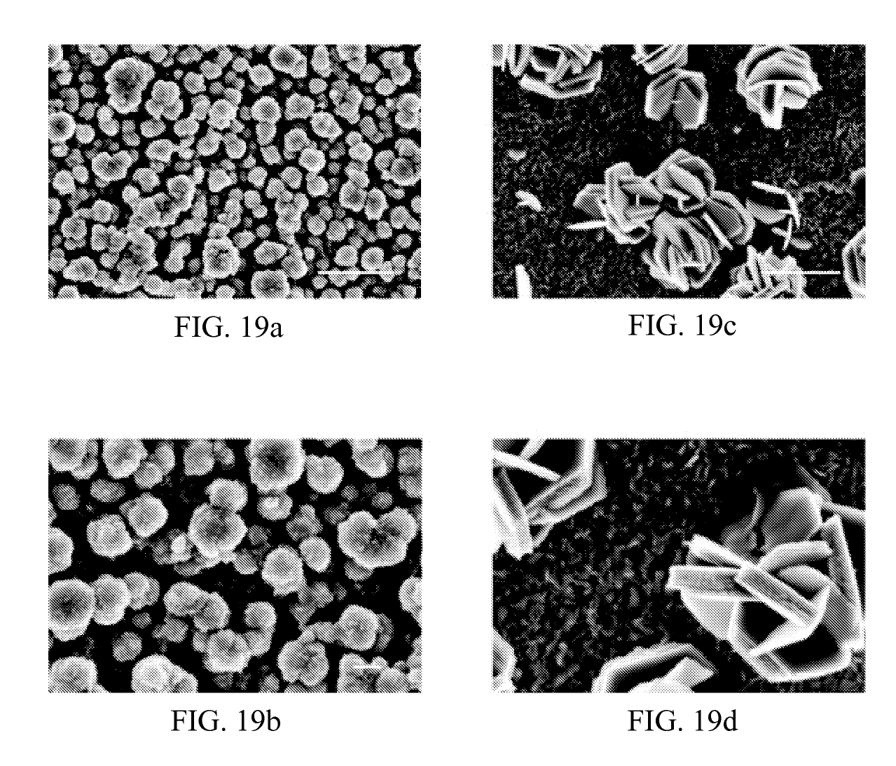

FIGS. 19a-19d show the scanning electron microscope (SEM) micrographs of cobalt foils that were subjected to an electrochemical potential of 3V for 2 hours in an electrolyte containing 5M NaOH that was maintained at a constant temperature of 60° C. Like FIGS. 18a and 18b, FIGS. 19a and 19b show cobalt oxide nanostructures aggregated to form wooly ball-like structures on the anode. These aggregations show a high surface roughness at magnifications of 25,000× and 50,000×, respectively. The diameter of the wooly ball-like structures vary between a few 10 s of nanometers to a few 100 s of nanometers. FIGS. 19c and 19d show the formation of hexagonal platelets assembled in rosettes on the cathode at 25,000× and 50,000× magnification. The hexagonal platelets are also stacked.

### Example 2D

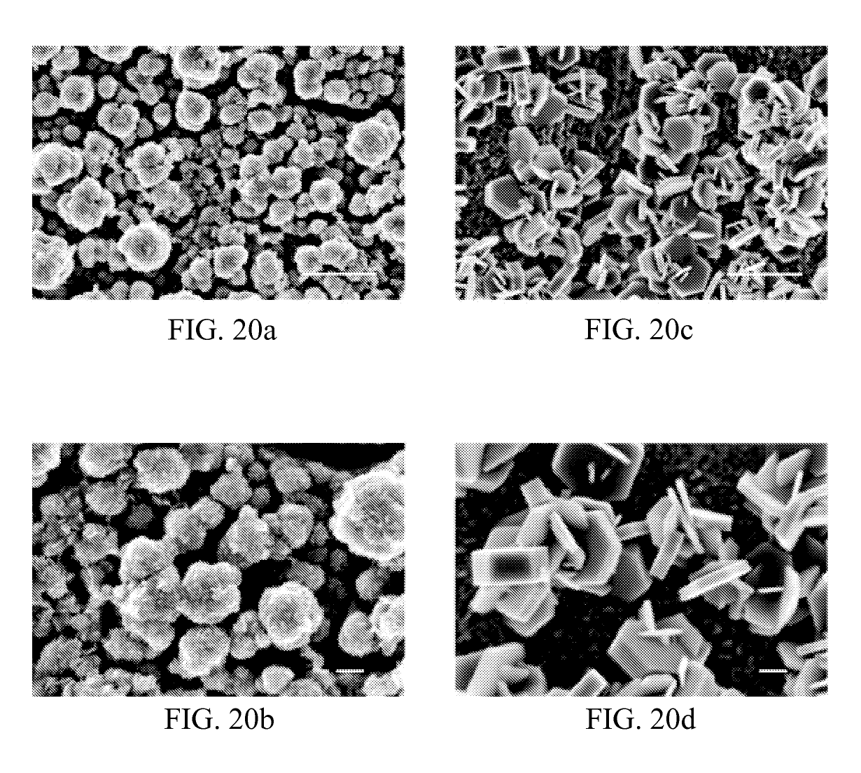

FIGS. 20a-20d show the scanning electron microscope (SEM) micrographs of cobalt foils that were subjected to an electrochemical potential of 3V for 2 hours in an electrolyte containing 5M KOH that was maintained at a constant temperature of 60° C. Like Examples 2B and 2C, FIGS. 20a and 20b show cobalt oxide rod-like nanostructures aggregated to form wooly ball-like structures. These wooly ball-like structures show a high surface roughness on the anode at magnifications of 25,000× and 50,000×, respectively. The diameter of the wooly ball-like structures varies between a few 10 s of nanometers to a few 100 s of nanometers. Sub-10 nm features can be seen within each of the structures as well, which relate to the rods comprising the wooly ball-like structures. FIGS. 20c and 20d show the formation of hexagonal platelets assembled in rosettes on the cathode at 25,000× and 50,000× magnification. The hexagonal platelets are also stacked, and notably, the edges of the hexagons appear sharper and more well-defined than in the previous cases.

### Example 2E

X-ray diffraction studies were carried out to deduce the composition of the cobalt oxide nanostructures. Decoupling the cobalt oxide structures from cobalt background using XRD was difficult on cobalt substrate due to the huge background from the substrate. For this purpose, an experiment was conducted where a titanium substrate was used as the cathode and cobalt substrate was used as anode. A constant potential of 3V was applied for 6 hours in a solution containing 5M KOH at 60° C.

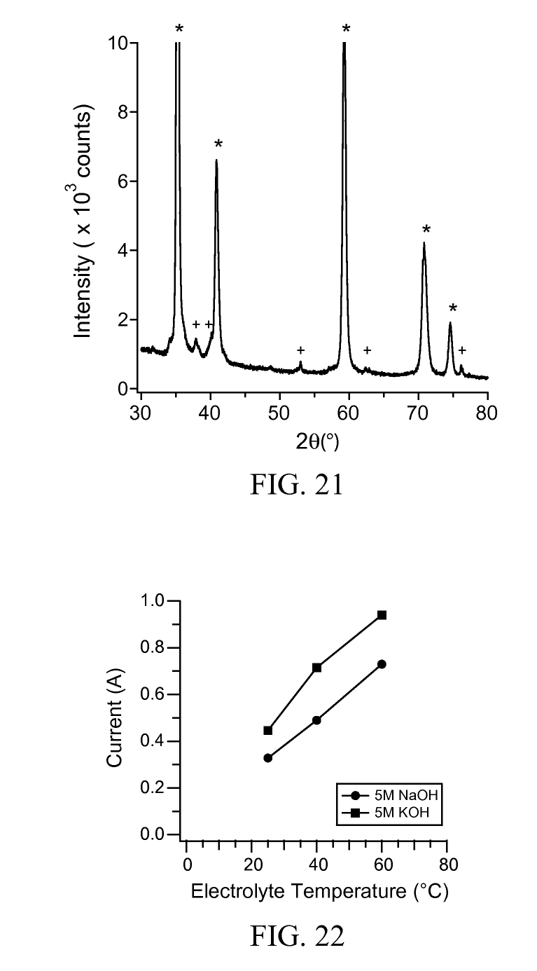

FIG. 21 shows the XRD spectrum of the titanium cathode from this experiment. XRD peaks indicating the presence of cobalt as cobalt (II) oxide are noted on the spectrum with “*”. Peaks corresponding to metallic cobalt were not observed on the spectrum, indicating all the cobalt is present as CoO. Titanium peaks are noted on the spectrum with “+”.

ICP analyses were also performed on the solutions after electrochemistry was done to identify residual cobalt or cobalt oxide that may have been discharged into the solution. ICP experiments did not detect cobalt in any form (as metal or as an oxide) in the solutions indicating complete transfer of material from the anode to the cathode.

Finally, FIG. 22 shows the substrate current recorded after 2 hours under a constant potential control at 3V as a function of temperature in 5M NaOH and KOH electrolytes. A steady increase in current (y-axis) with temperature α-axis) is observed in both of the electrolytes, indicating higher rates of electrochemical reactions with increasing temperatures.

### Example 3

Additional experiments were performed using the same type of zinc foils and experimental set up as described in Example 1.

### Example 3A

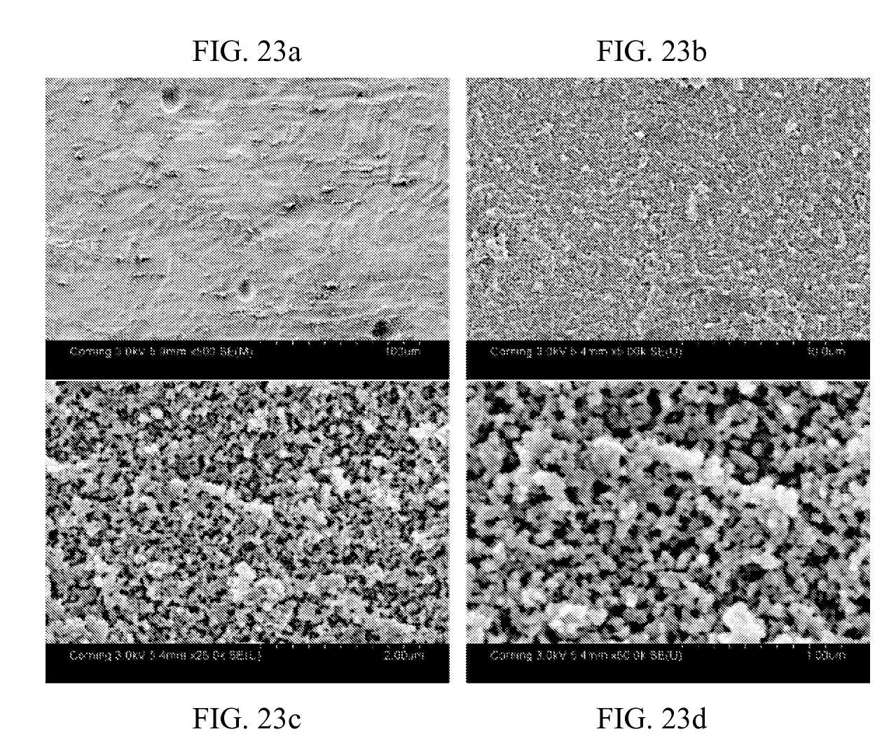

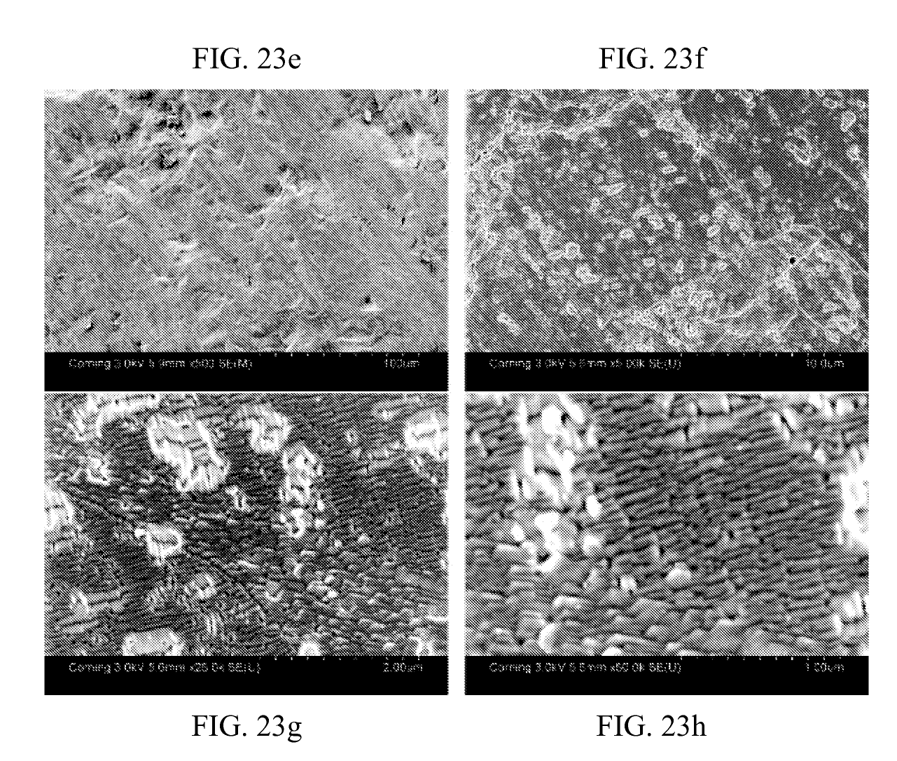

FIGS. 23a-23h show the SEM micrographs of zinc foils/electrodes that were subjected to an electrochemical potential of 3V for 5 minutes in a solution containing 5M NaOH. Porous network-like structures formed on the anode. FIGS. 23a-23d show the anode at magnifications of 500×, 5,000×, 25,000× and 50,000× respectively. Highly porous structures are clearly observed.

FIGS. 23e-23h show the cathode at magnifications of 500×, 5,000×, 25,000× and 50,000× respectively. The surface of the cathode has become textured and platelet-like structures are scattered across the surface.

### Example 3B

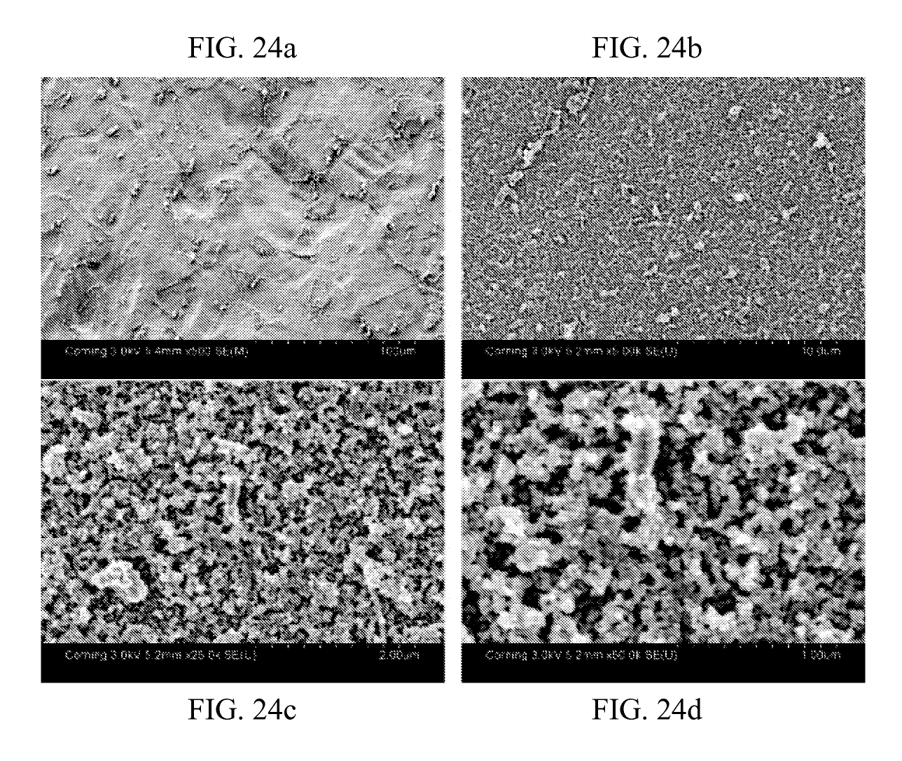

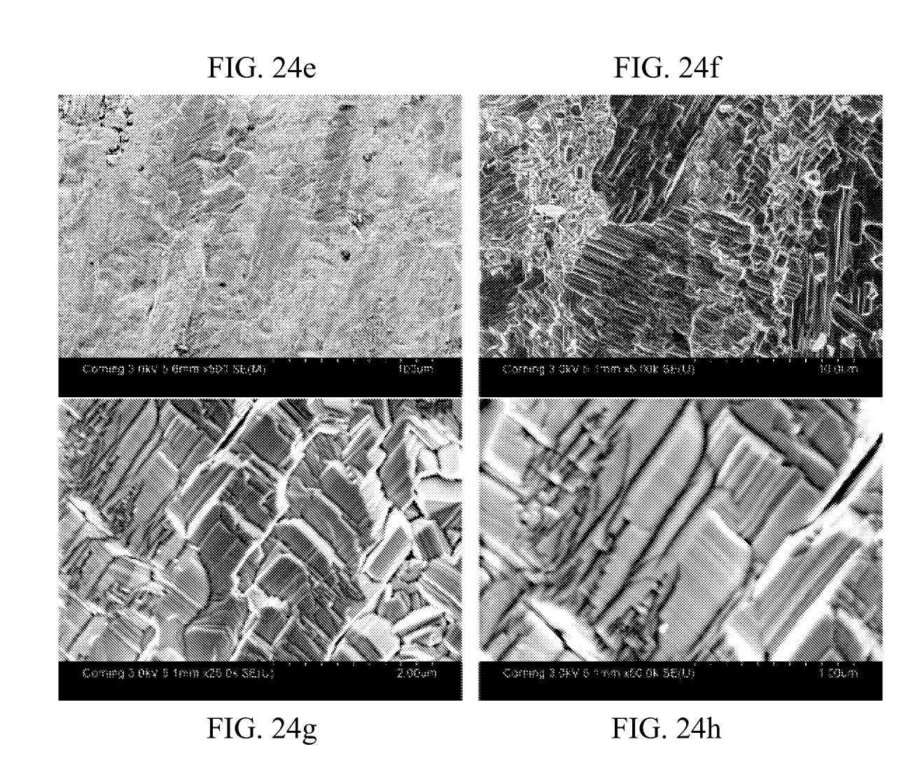

FIGS. 24a-24h show the SEM micrographs of zinc foils/electrodes that were subjected to an electrochemical potential of 3V for 5 minutes in a solution containing 5M KOH. Porous network-like structures, much like those of Example 3A, are clearly observed. FIGS. 24a-24d show the anode at magnifications of 500×, 5,000×, 25,000× and 50,000× respectively.

FIGS. 24e-24h show the cathode at magnifications of 500×, 5,000×, 25,000× and 50,000× respectively. The surface of the cathode is covered with platelet-like structures stacked upon one another across the surface.

### Example 3C

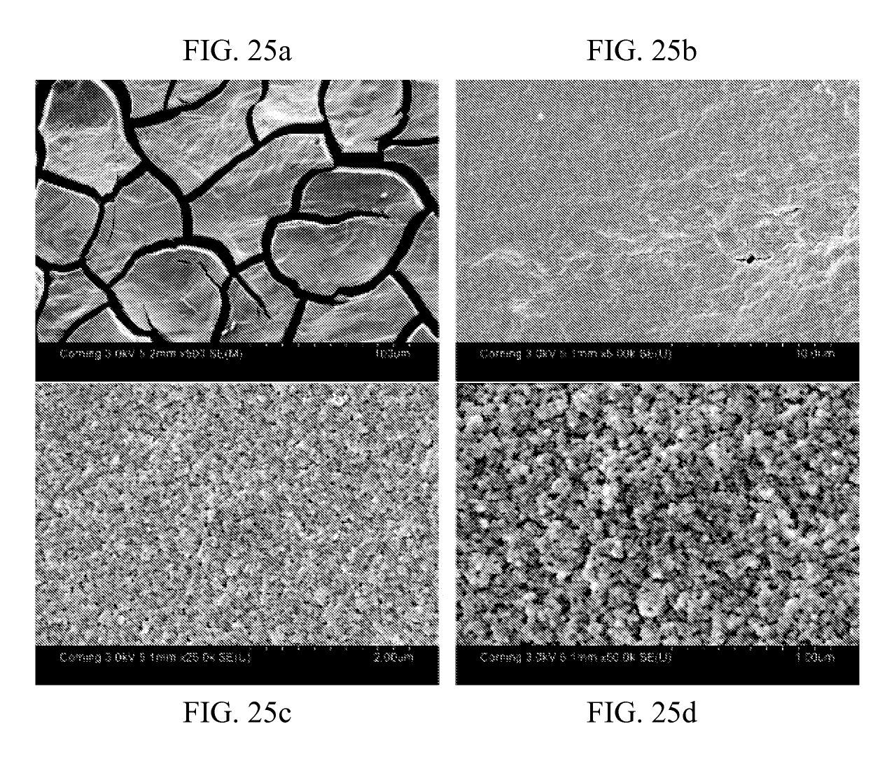

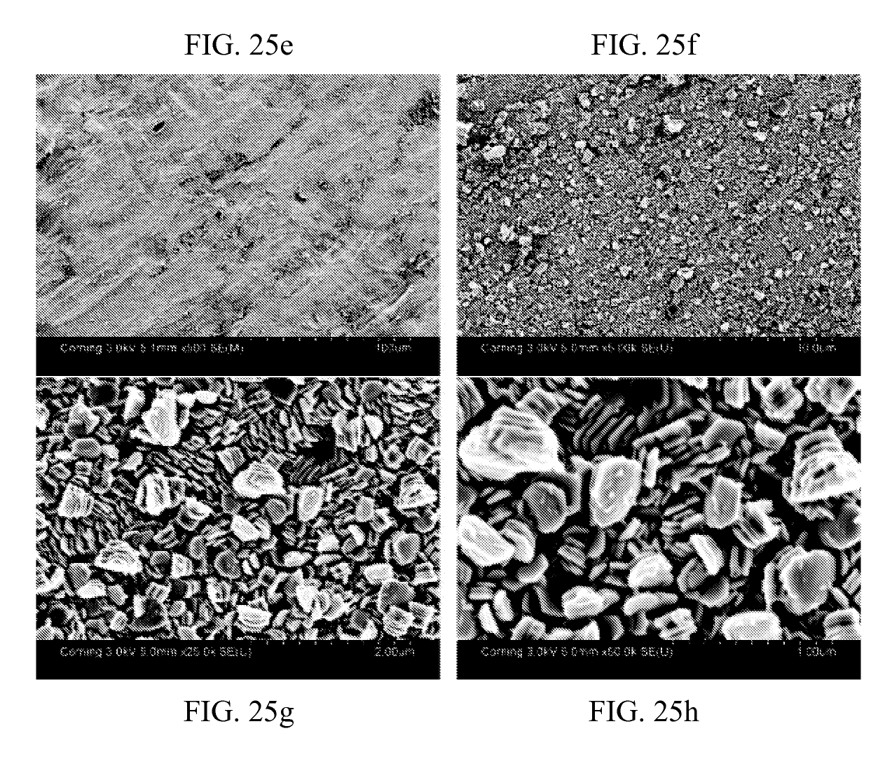

FIGS. 25a-25h show the SEM micrographs of zinc foils/electrodes that were subjected to an electrochemical potential of 3V for 15 minutes in a solution containing 5M NaOH. FIGS. 25a-25d show the anode at magnifications of 500×, 5,000×, 25,000× and 50,000× respectively. Porous network-like structures, much like those of Examples 3A and 3B, are clearly observed. In this case, however, the structures are more densely packed, as seen in FIG. 25d in particular. Additionally, as seen in FIG. 25a, the nanostructure layer on the anode has cracked, forming large flakes material.

FIGS. 25e-25h show the cathode at magnifications of 500×, 5,000×, 25,000× and 50,000× respectively. The platelet structures on the cathode are more defined than in Examples 3A and 3B, and the stacking of the platelets is also more evident.

### Example 3D

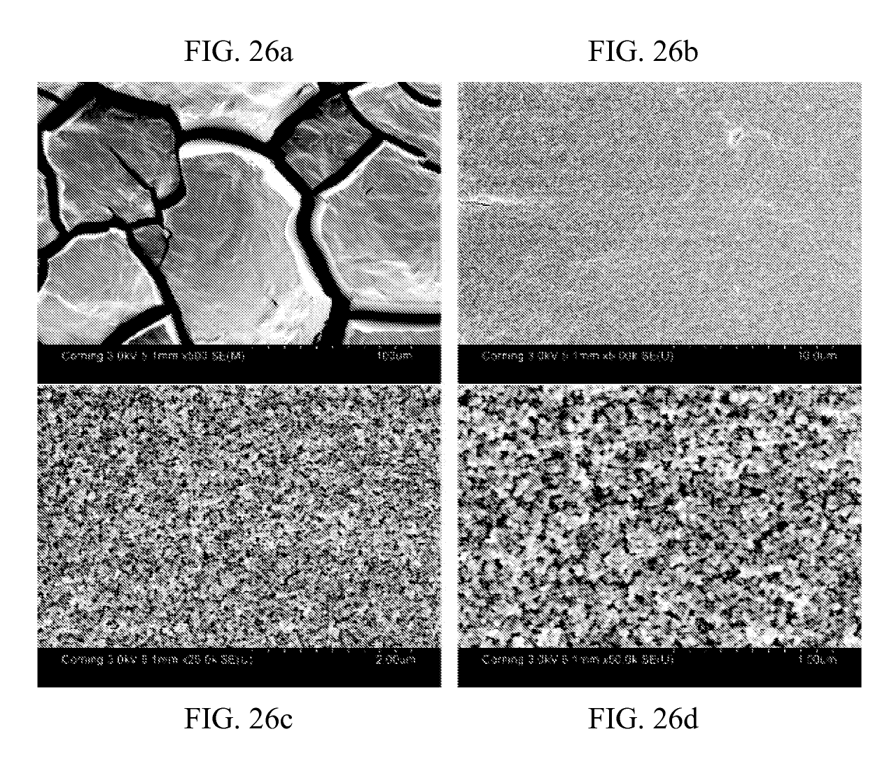

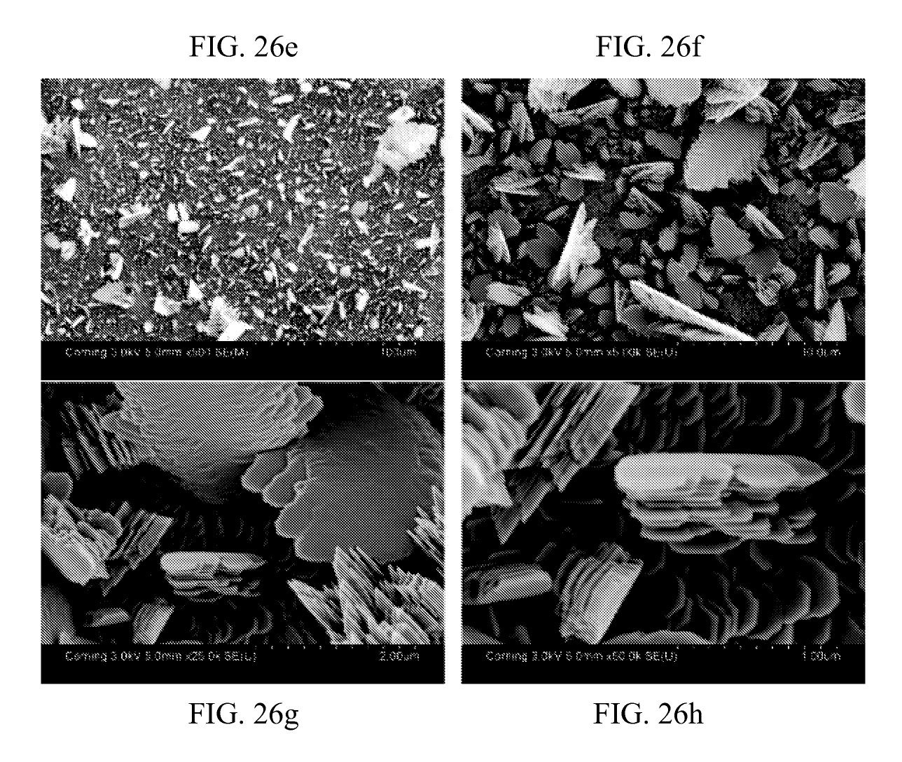

FIGS. 26a-26h show the SEM micrographs of zinc foils/electrodes that were subjected to an electrochemical potential of 3V for 15 minutes in a solution containing 5M KOH. FIGS. 26a-26d show the anode at magnifications of 500×, 5,000×, 25,000× and 50,000× respectively. Porous network-like structures, much like those of Example 3C, are clearly observed. The structures are densely packed, and as seen in FIG. 26a, the nanostructure layer on the anode has cracked, forming large flakes material.

FIGS. 26e-26h show the cathode at magnifications of 500×, 5,000×, 25,000× and 50,000× respectively. The platelet structures on the cathode are much like those of Examples 3C. The platelets and stacking of the platelets is well-defined. Notably, the stacked platelets also appear to be less crowded or have fewer surfaces touching one another.

### Example 3E

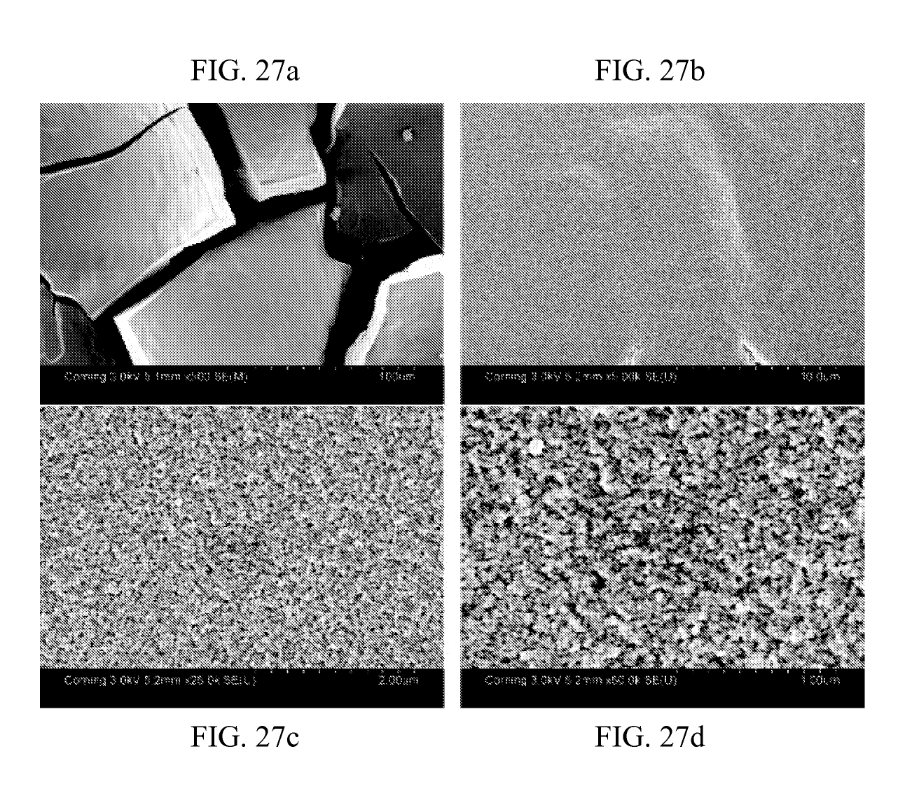

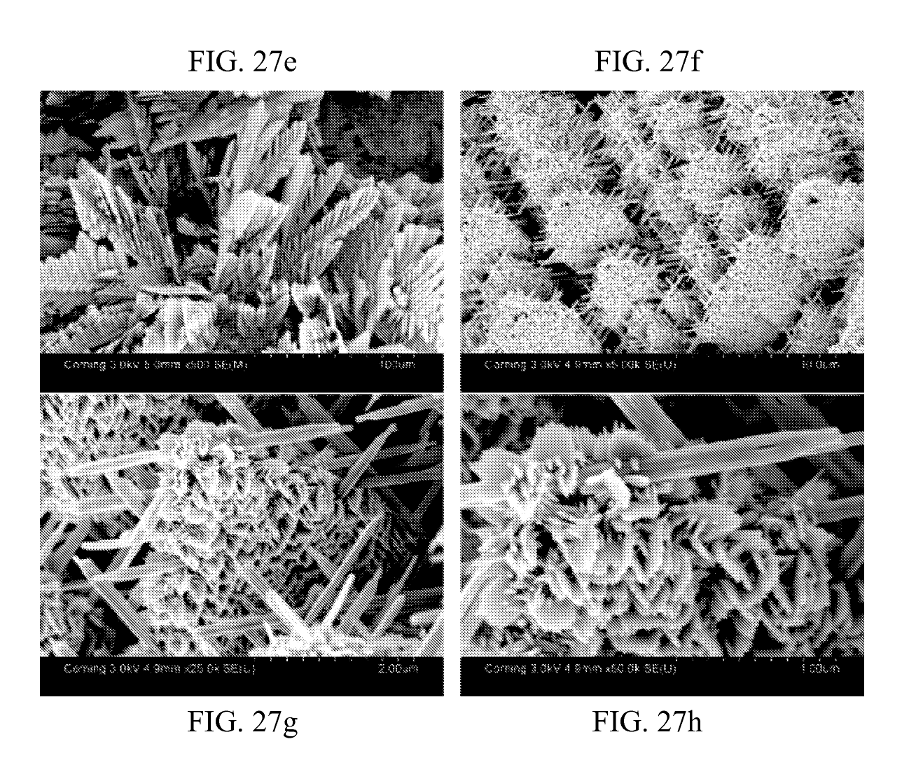

FIGS. 27a-27h show the SEM micrographs of zinc foils/electrodes that were subjected to an electrochemical potential of 3V for 30 minutes in a solution containing 5M NaOH. FIGS. 27a-27d show the anode at magnifications of 500×, 5,000×, 25,000× and 50,000× respectively. Porous network-like structures, much like those of Examples 3A-3D are clearly observed. In this case, however, the structures are even more densely packed, as seen in FIG. 27d in particular. Additionally, as seen in FIG. 27a, the nanostructure layer on the anode has cracked, forming large flakes material, which are larger than those seen in Example 3C and 3D.

FIGS. 27e-27h show the cathode at magnifications of 500×, 5,000×, 25,000× and 50,000× respectively. Well-defined leaf-like structures are seen on the cathode. Rods appear as secondary structures radiating from the leaf axis. Additionally, the surfaces also appear covered with platelets as secondary structures, which are comprised of at least one subnanometer dimension.

### Example 3F

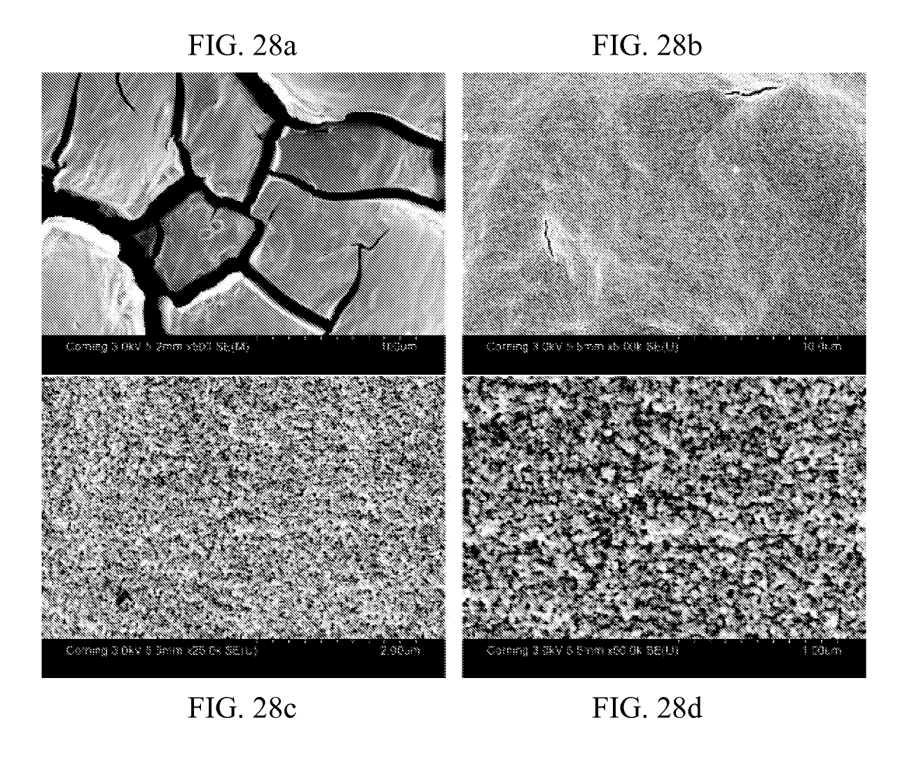

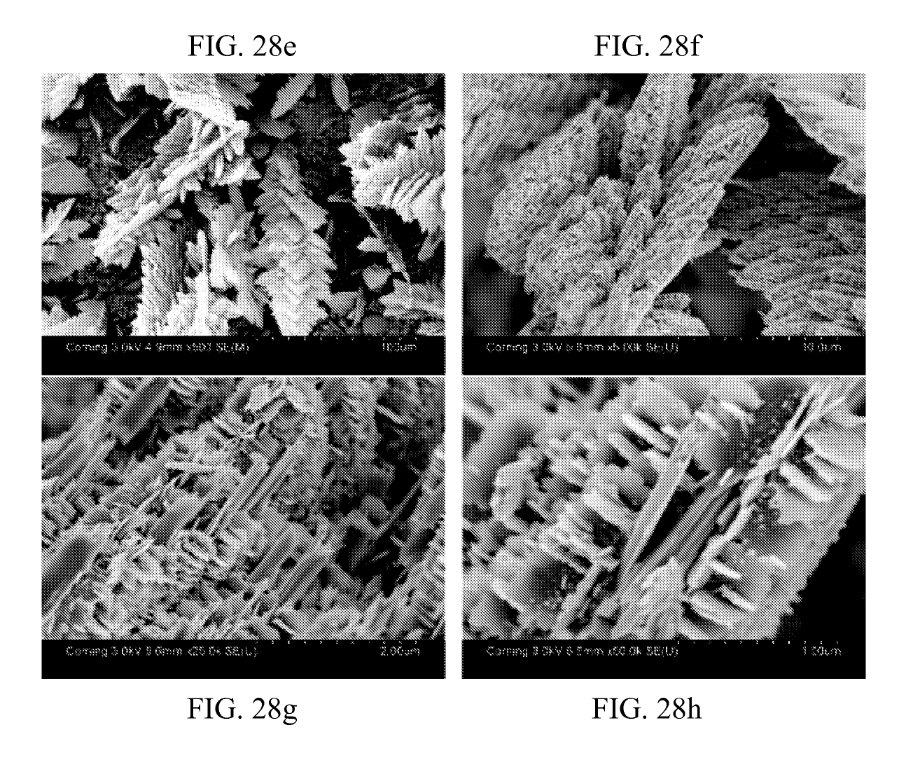

FIGS. 28a-28h show the SEM micrographs of zinc foils/electrodes that were subjected to an electrochemical potential of 3V for 30 minutes in a solution containing 5M KOH. FIGS. 28a-28d show the anode at magnifications of 500×, 5,000×, 25,000× and 50,000× respectively. Porous network-like structures, much like those of Example 3E, are clearly observed. The structures are densely packed, and as seen in FIG. 28a, the material has cracked, forming large flakes.

FIGS. 28e-28h show the cathode at magnifications of 500×, 5,000×, 25,000× and 50,000× respectively. Well-defined leaf-like structures are seen on the cathode. Subnanometer platelets appear as secondary structures radiating from the leaf axis.

### Example 3G

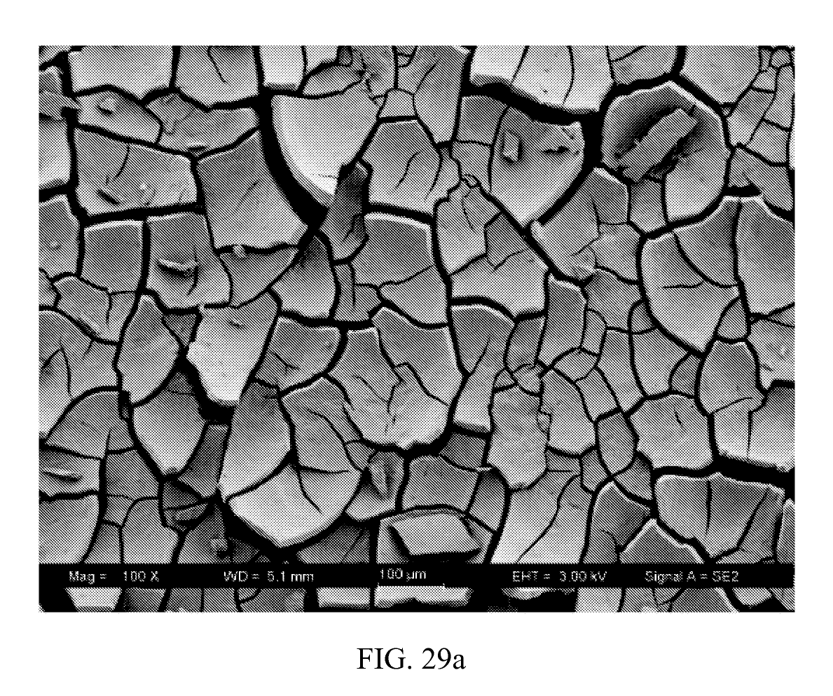

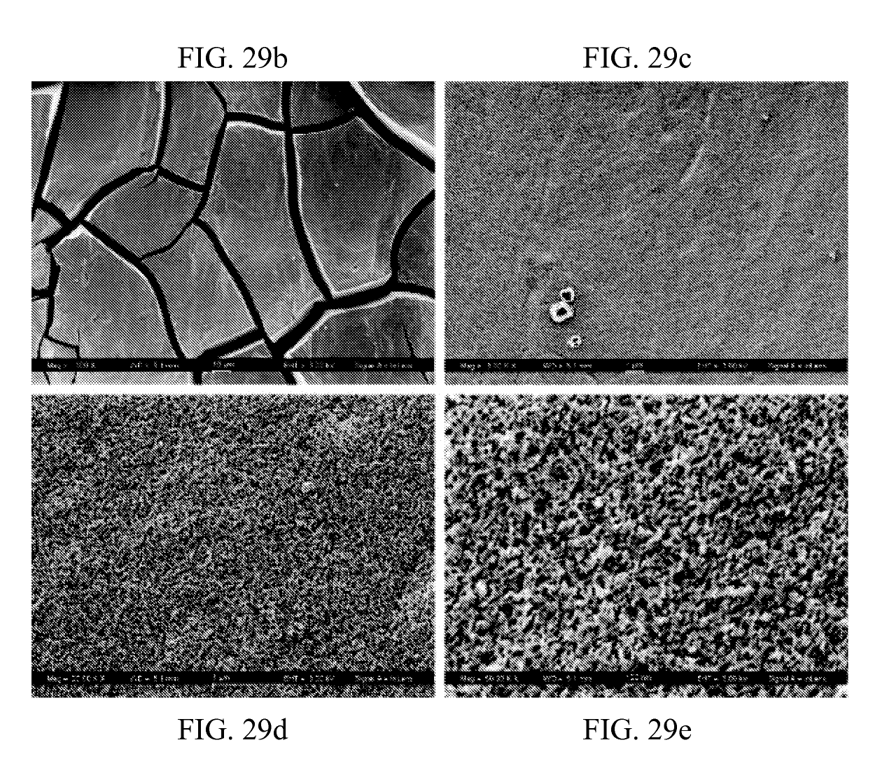

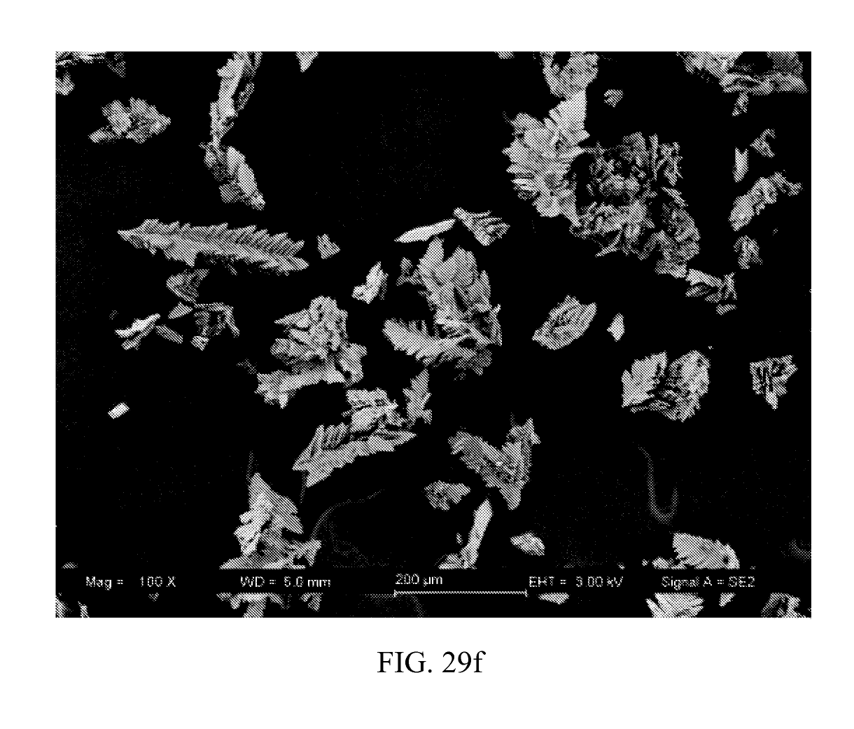

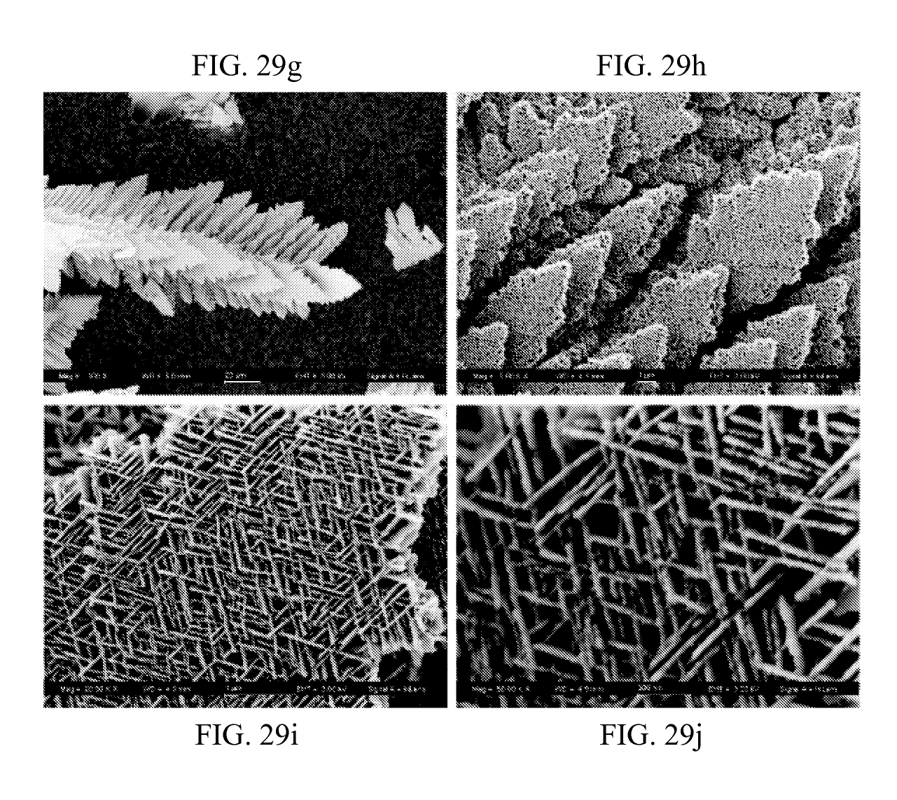

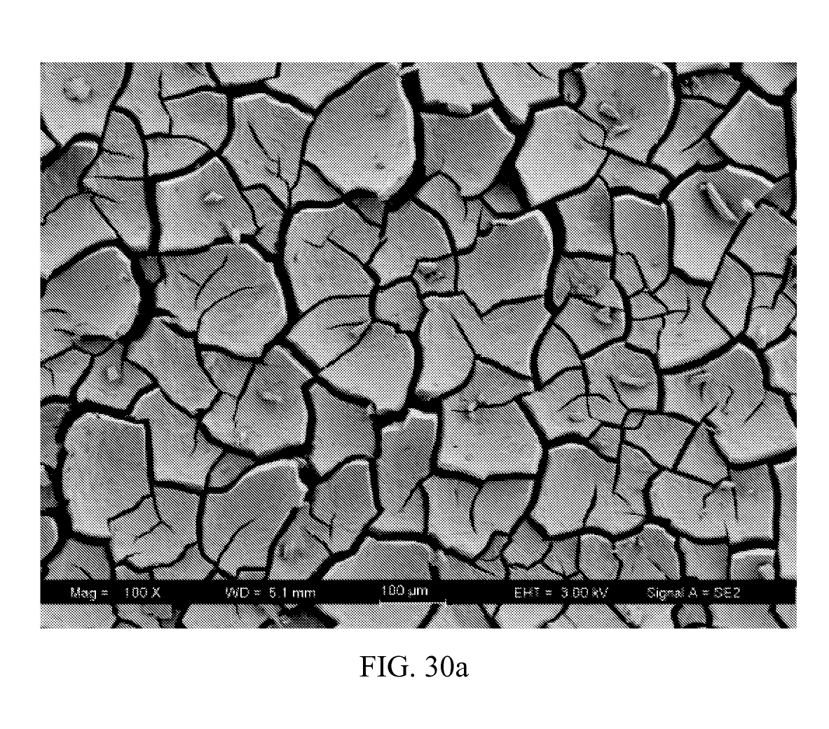

FIGS. 29a-29j show the SEM micrographs of zinc foils/electrodes that were subjected to an electrochemical potential of 3V for 30 minutes in a solution containing 5M NaOH. FIGS. 29a-29e show the anode at magnifications of 100×, 500×, 5,000×, 20,000× and 50,000× respectively. Porous network-like structures, much like those of the other cases in Example 3, are clearly observed. The structures are densely packed, and as seen in FIG. 29a, the material has cracked, forming large flakes. It appears the flakes are less than 100 nm thick.

FIGS. 29f-28h show the cathode at magnifications of 100×, 500×, 5,000×, 20,000× and 50,000× respectively. Well-defined leaf-like structures are seen on the cathode. As is apparent from FIGS. 29g and 29h, cross-hatches appear as secondary structures on the surfaces of the leaf-like structure. The stacked structures are not crowded, with few surfaces touching one another.

### Example 3H

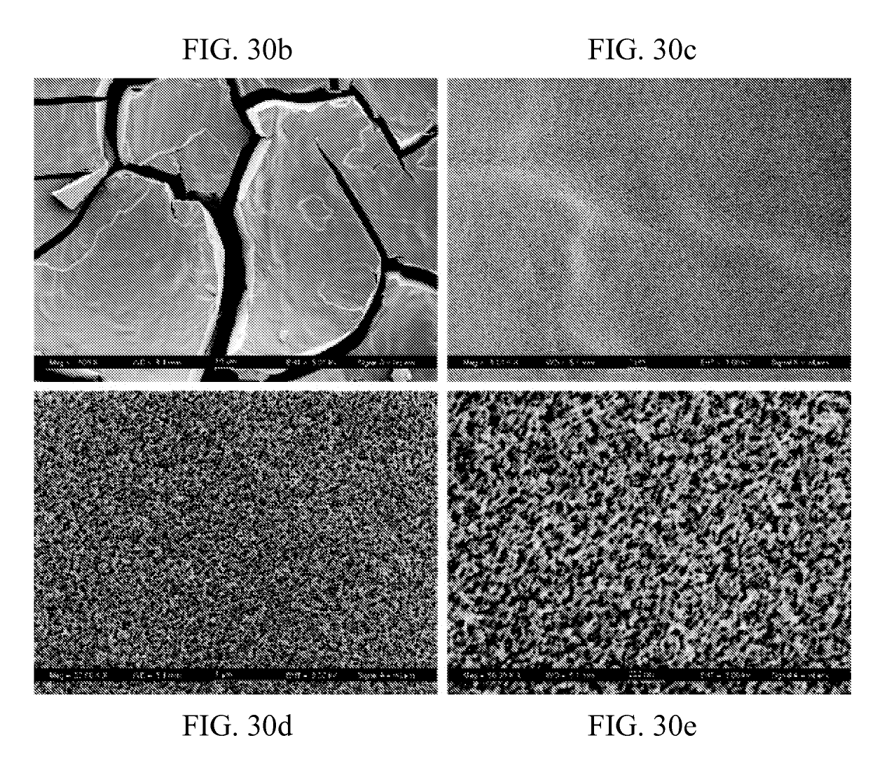

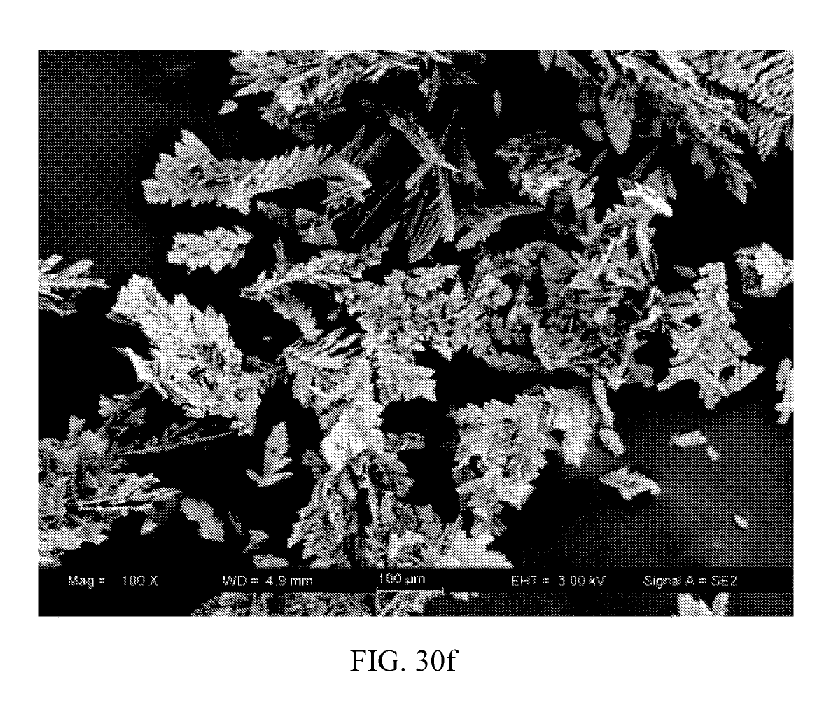

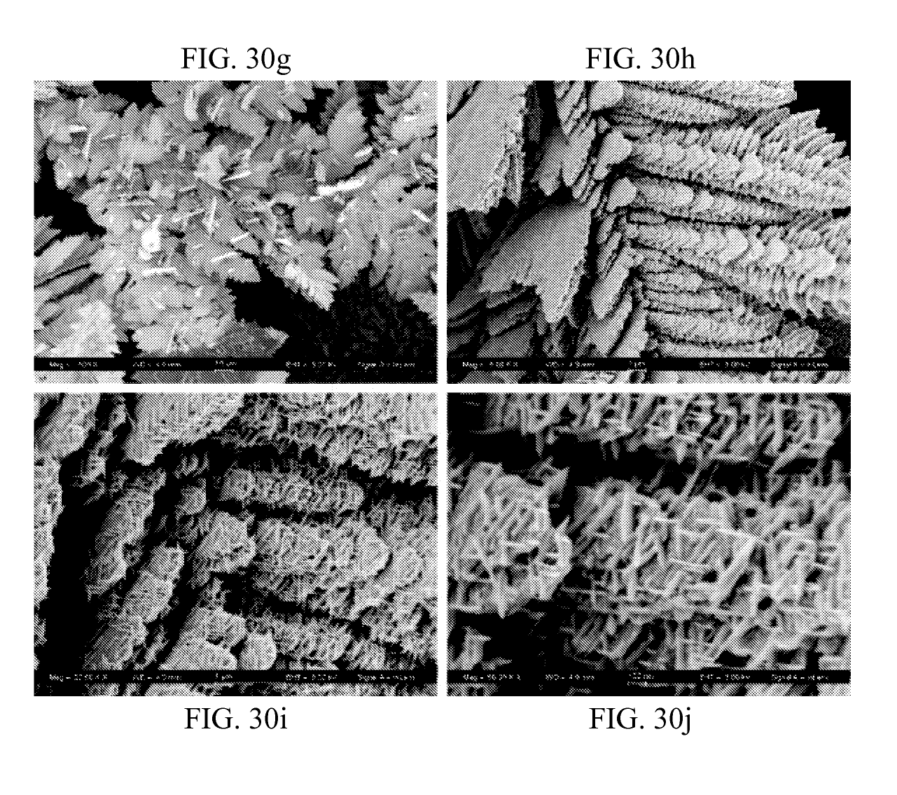

FIGS. 30a-30j show the SEM micrographs of zinc foils/electrodes that were subjected to an electrochemical potential of 3V for 30 minutes in a solution containing 5M KOH. FIGS. 30a-30e show the anode at magnifications of 100×, 500×, 5,000×, 20,000× and 50,000× respectively. Porous network-like structures, much like those of Example 3G, are clearly observed. The structures are densely packed, and as seen in FIG. 30a, the material has cracked, forming large flakes.

FIGS. 30f-30h show the cathode at magnifications of 100×, 500×, 5,000×, 20,000× and 50,000× respectively. Like Example 3G, well-defined leaf-like structures are seen on the cathode. As is apparent from FIGS. 30g and 30h, cross-hatches and rods appear as secondary structures on the surfaces of the leaf-like structure. The stacked structures appear more crowded or grouped together than in Example 3G.

### Example 3I

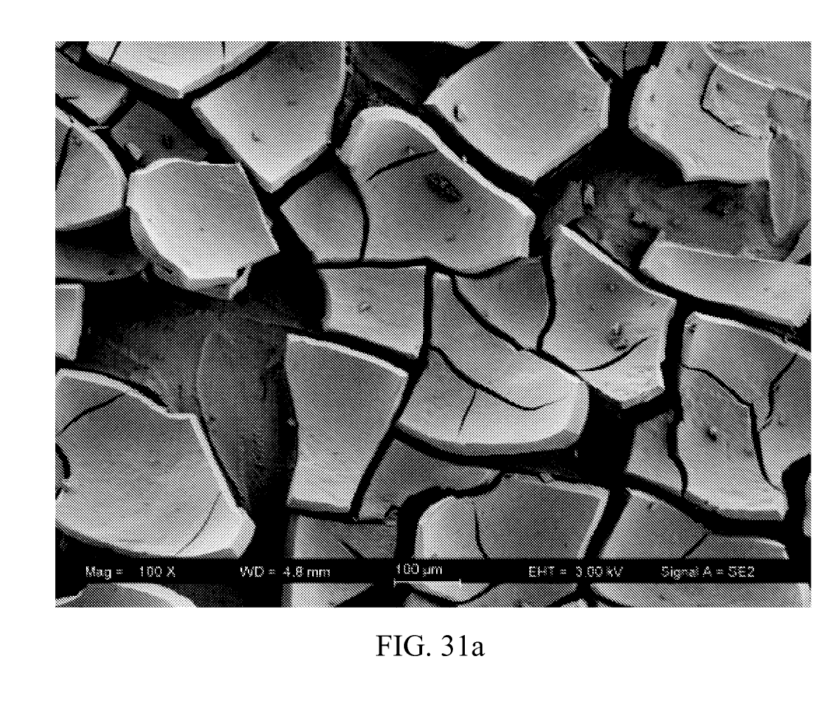

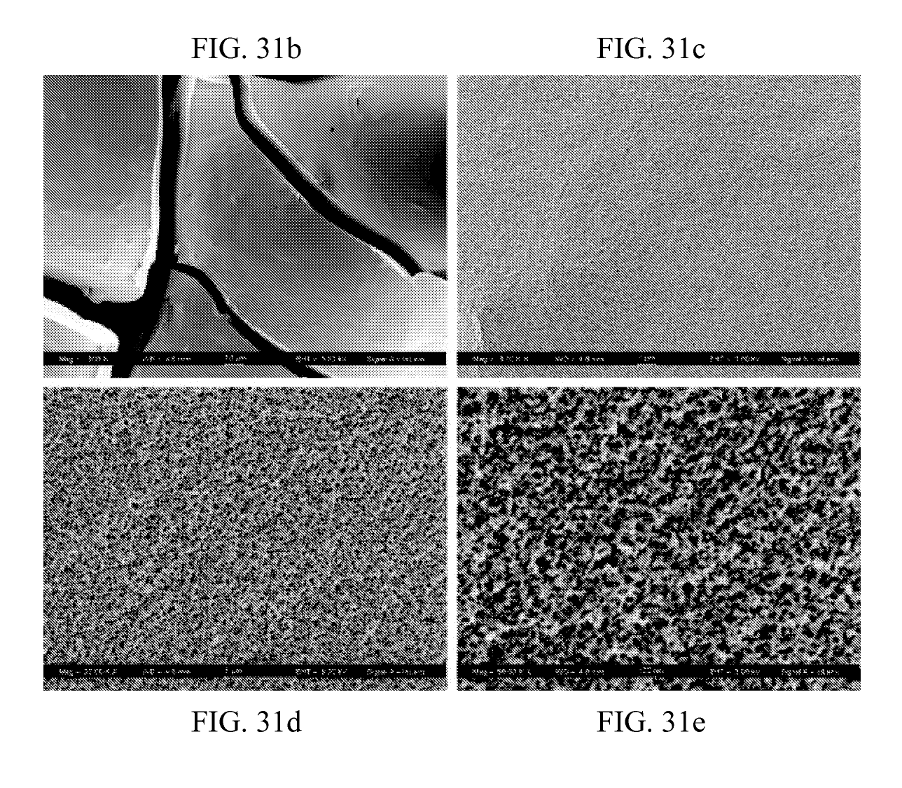

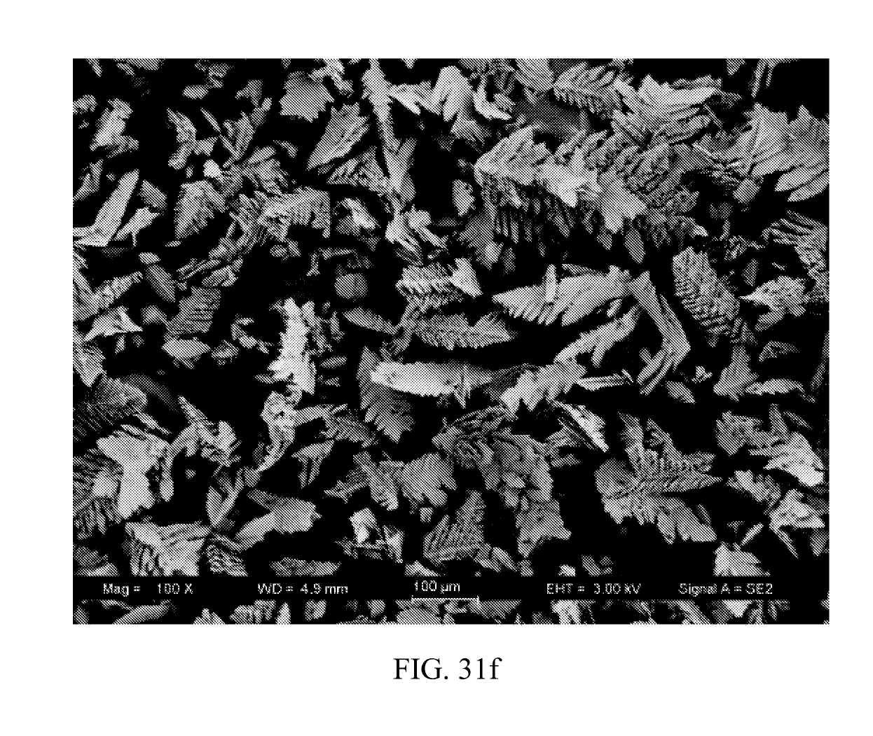

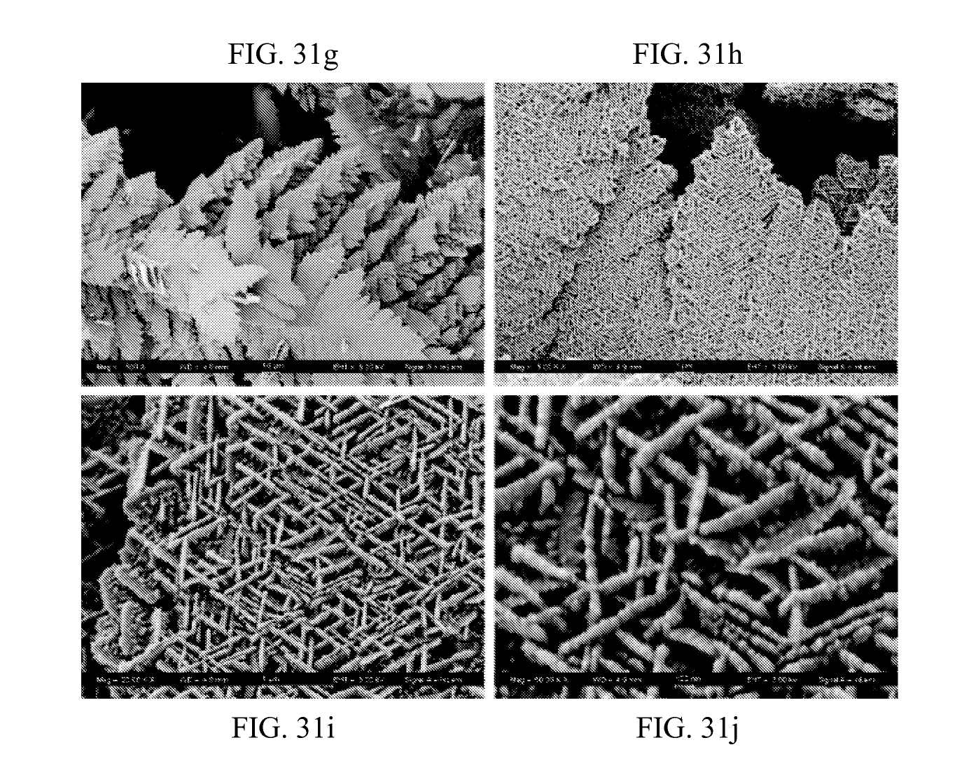

FIGS. 31a-31j show the SEM micrographs of zinc foils/electrodes that were subjected to an electrochemical potential of 3V for 60 minutes in a solution containing 5M NaOH. FIGS. 31a-31e show the anode at magnifications of 100×, 500×, 5,000×, 20,000× and 50,000× respectively. Porous network-like structures, much like those of the other cases in Example 3, are clearly observed. The structures are densely packed, and as seen in FIG. 31a, the material has cracked, forming large flakes. It appears the flakes are less than 100 nm thick.

FIGS. 31f-31h show the cathode at magnifications of 100×, 500×, 5,000×, 20,000× and 50,000× respectively. Well-defined leaf-like structures are seen on the cathode. As is apparent from FIGS. 31g and 31h, dense cross-hatches appear as secondary structures on the surfaces of the leaf-like structure. Unlike Example 3G, the stacked structures are more numerous and grouped together.

### Example 3J

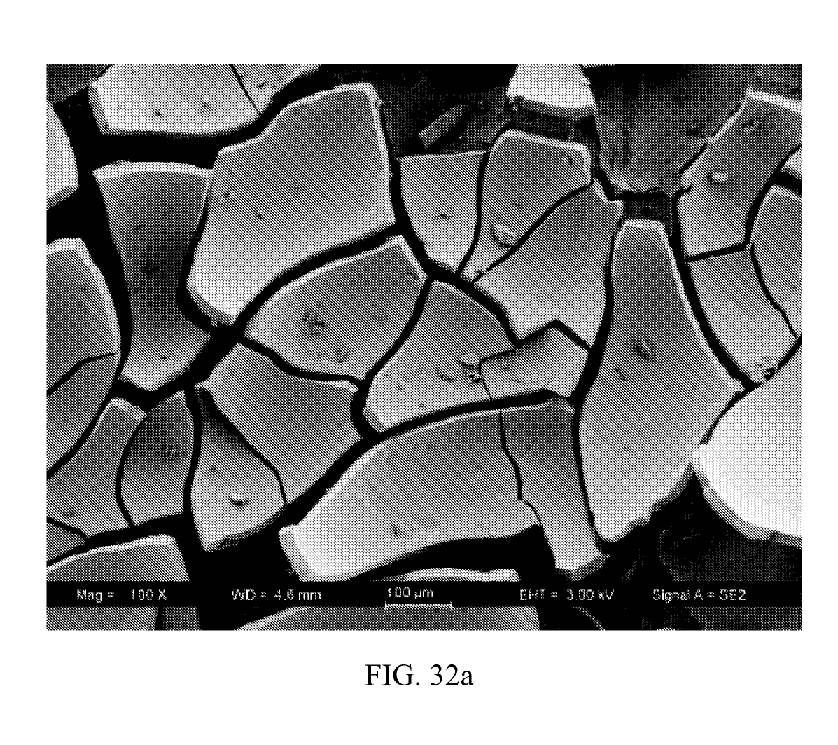

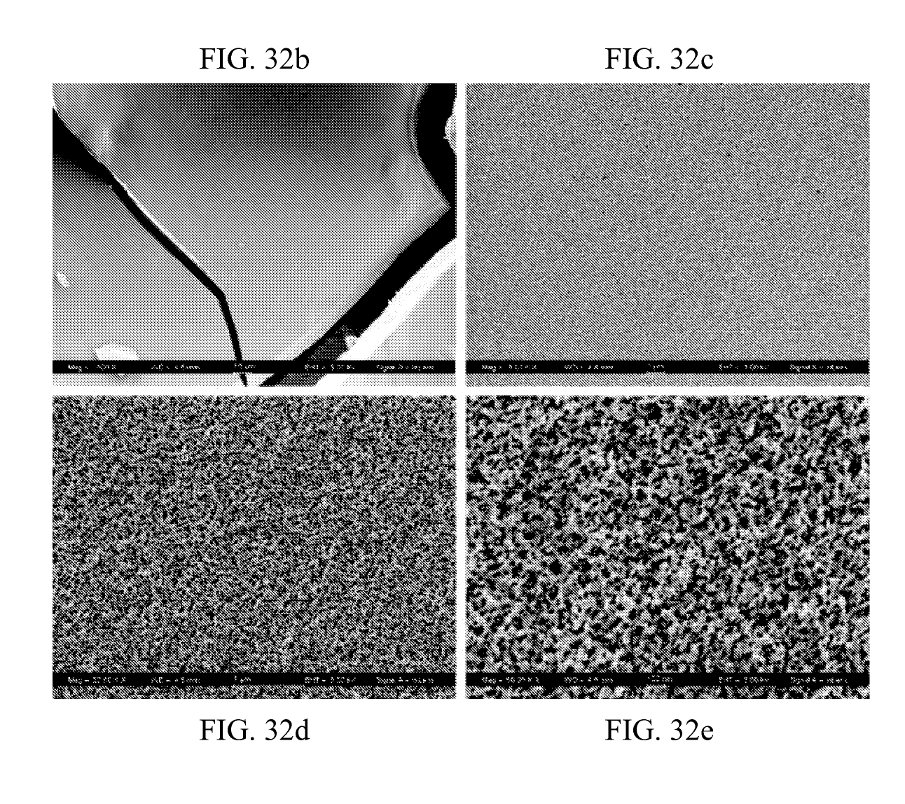

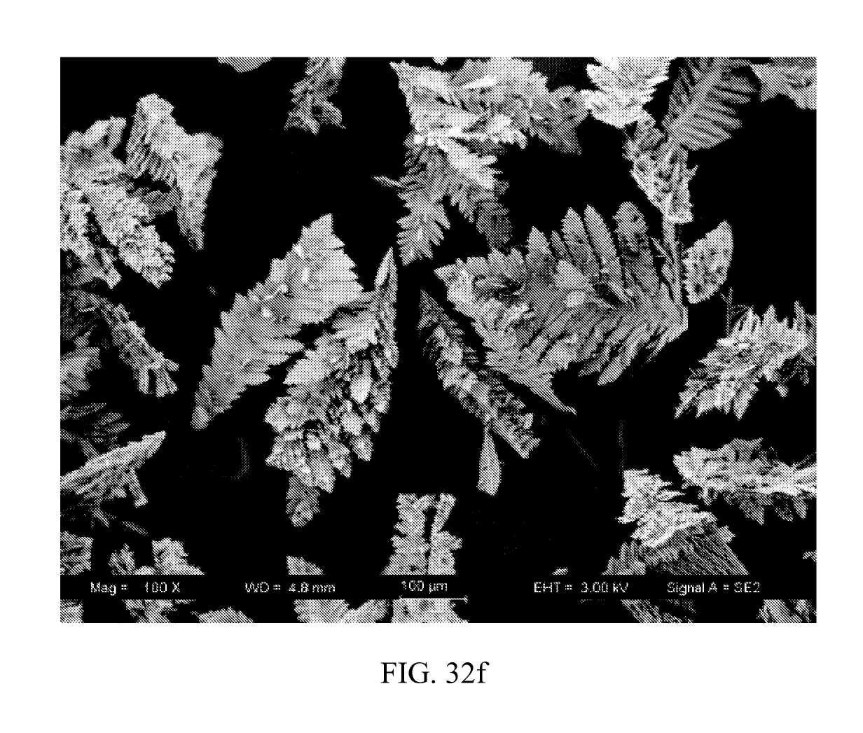

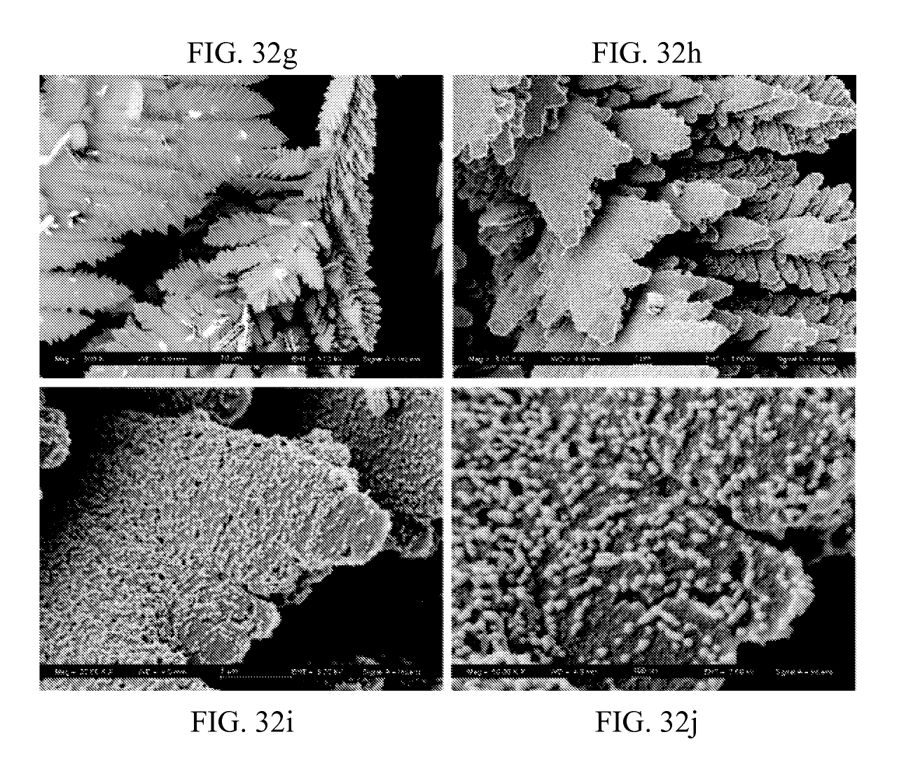

FIGS. 32a-32j show the SEM micrographs of zinc foils/electrodes that were subjected to an electrochemical potential of 3V for 60 minutes in a solution containing 5M KOH. FIGS. 32a-32e show the anode at magnifications of 100×, 500×, 5,000×, 20,000× and 50,000× respectively. Porous network-like structures, much like those of the other cases in Example 3, are clearly observed. The structures are densely packed, and as seen in FIG. 32a, the material has cracked, forming large flakes. It appears the flakes are less than 100 nm thick.

FIGS. 32f-32h show the cathode at magnifications of 100×, 500×, 5,000×, 20,000× and 50,000× respectively. Well-defined leaf-like structures are seen on the cathode. As is apparent from FIGS. 32g and 32h, grains appear as secondary structures on the surfaces of the leaf-like structure. The stacked structures are not crowded, as in Example 3I, but the structures appear larger.

### Example 4

Additional experiments were performed using the same type of zinc foils and experimental set up as described in Examples 1 and 3. In this series of experiments, zinc foils/electrodes were subjected to an electrochemical potential of 3V for 15 minutes in a 5M electrolyte solution. The composition of the solution varied for each sample as set forth in Table 1 below.

TABLE 1
Composition of Electrolyte Solution

| Sample ID | NaOH (mol %) | KOH (mol %) |
|---|---|---|
| 4A | 100 | 0 |
| 4B | 75 | 25 |
| 4C | 50 | 50 |
| 4D | 25 | 75 |
| 4E | 0 | 100 |

### Example 4A

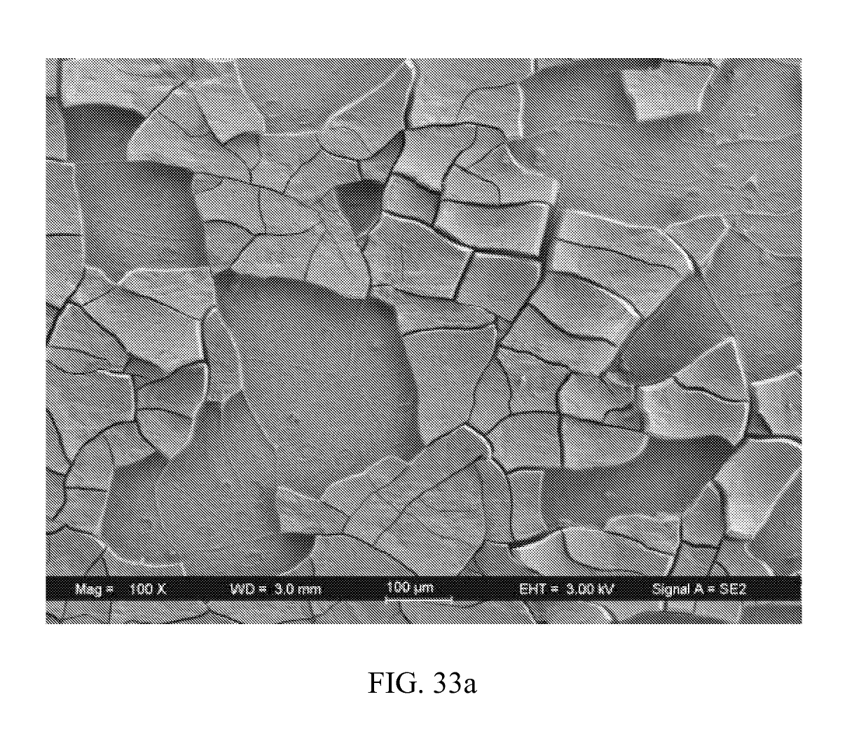

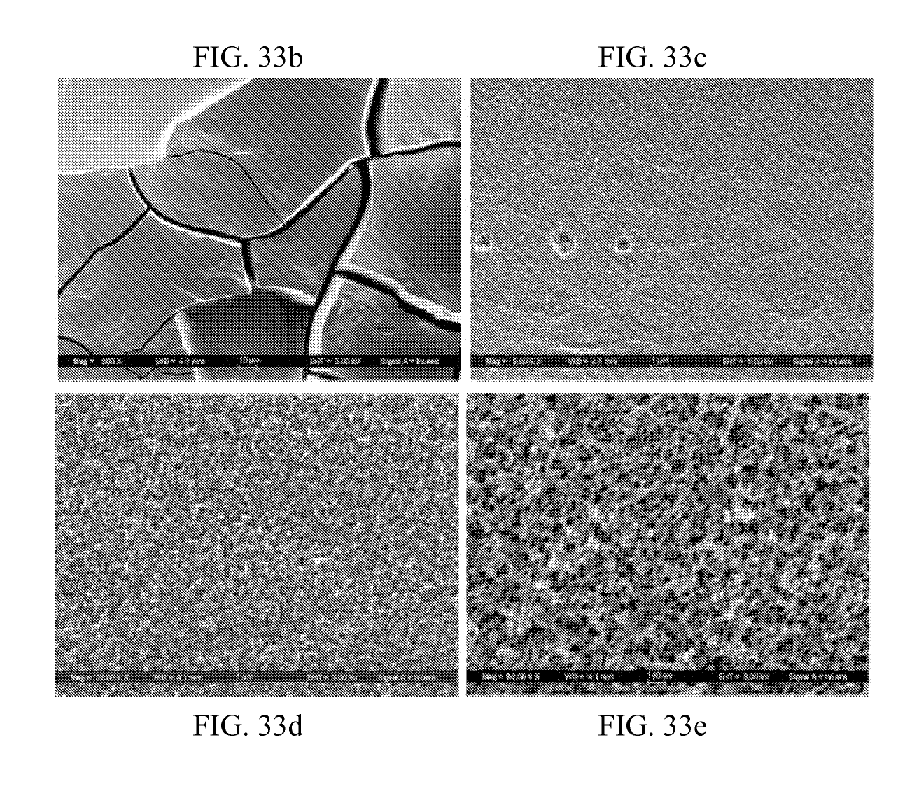

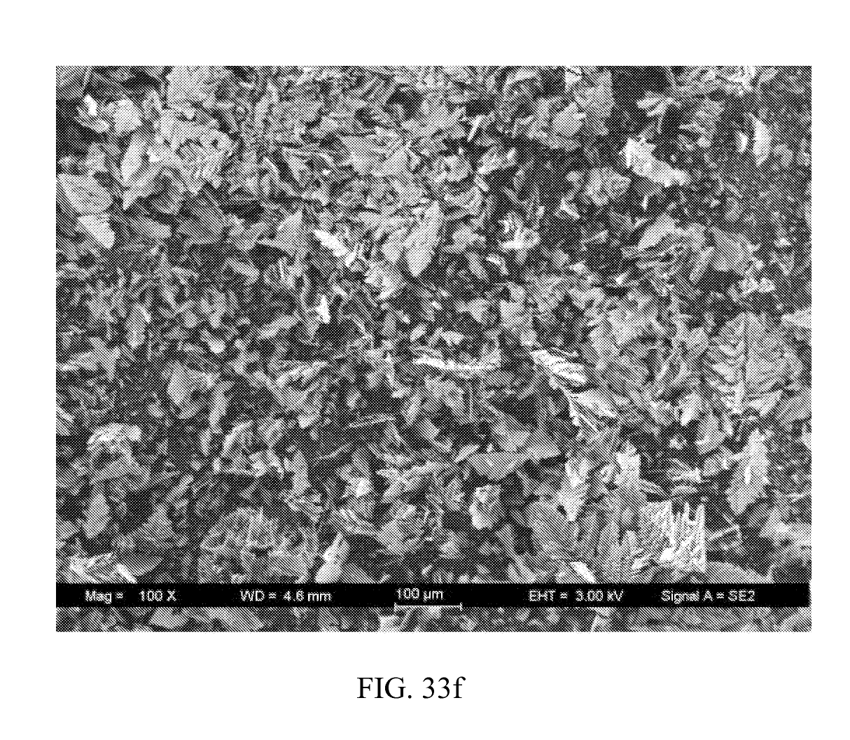

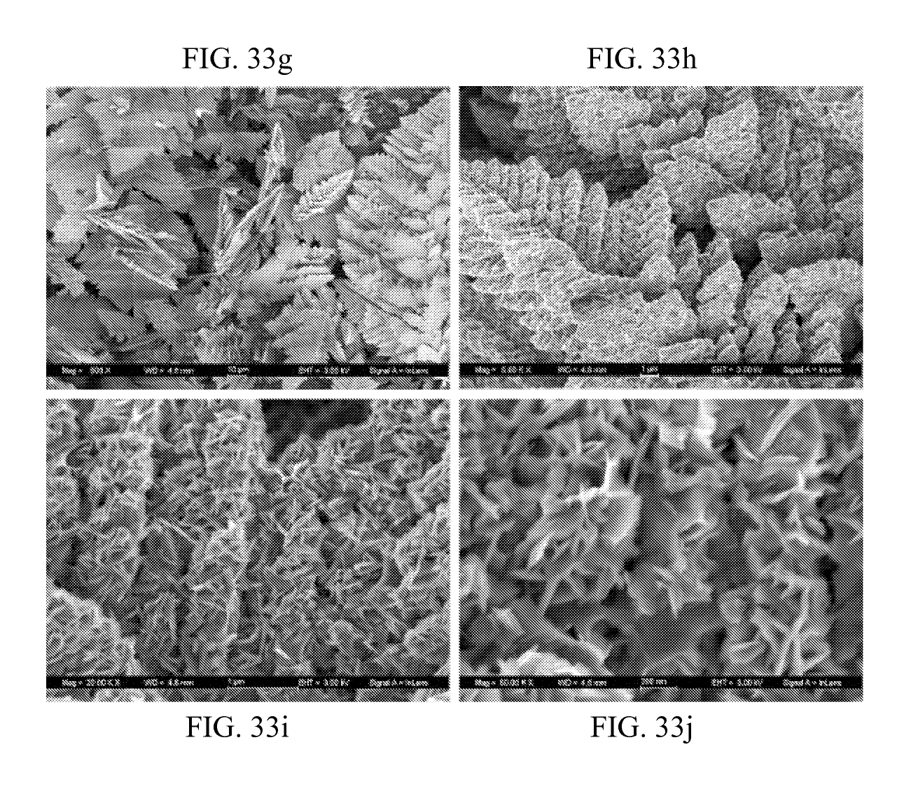

FIGS. 33a-33j show the SEM micrographs of zinc foils/electrodes for Sample 4A. Porous network-like structures formed on the anode. FIGS. 33a-33e show the anode at magnifications of 100×, 500×, 5,000×, 20,000× and 50,000× respectively. Highly porous structures are clearly observed. The structures are densely packed, and as seen in FIG. 33a, the material has cracked, forming large flakes. It appears the flakes are less than 100 nm thick.

FIGS. 33f-33j show the cathode at magnifications of 100×, 500×, 5,000×, 20,000× and 50,000× respectively. Well-defined leaf-like structures are seen on the cathode. As is apparent from FIGS. 33g and 33h, platelets and cross-hatches appear as secondary structures on the surfaces of the leaf-like structure.

### Example 4B

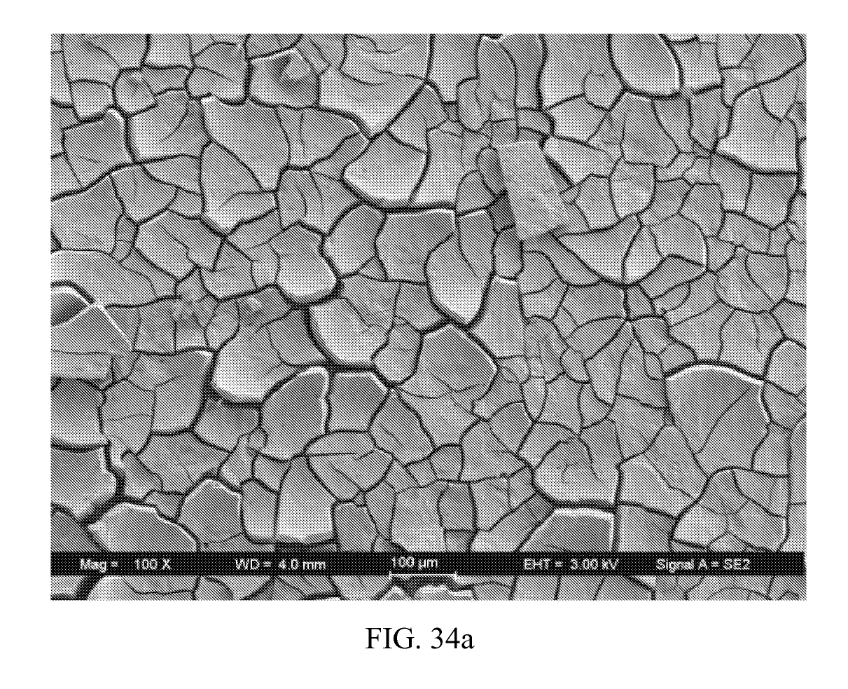

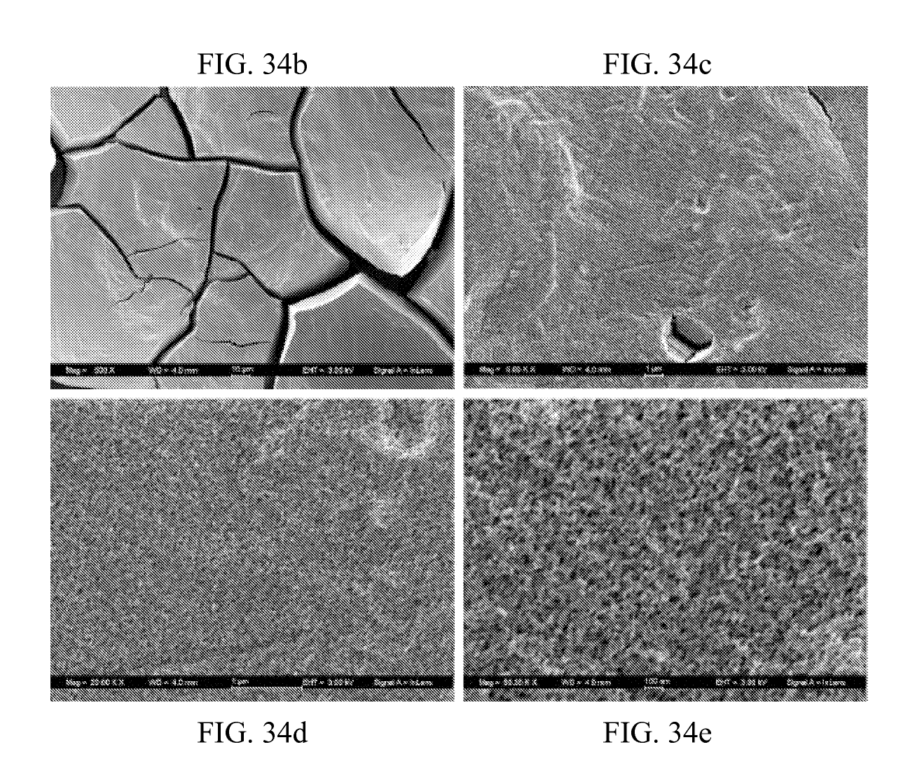

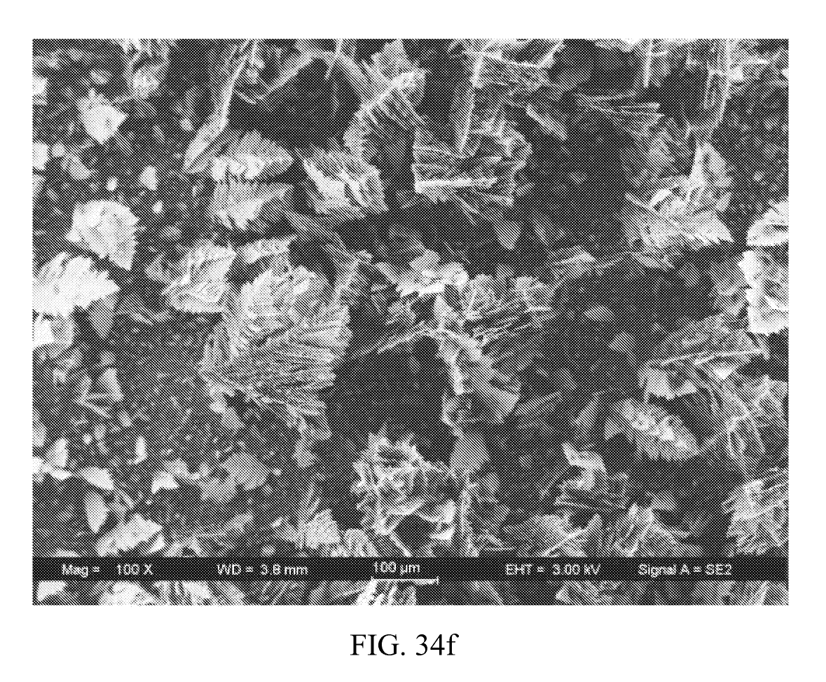

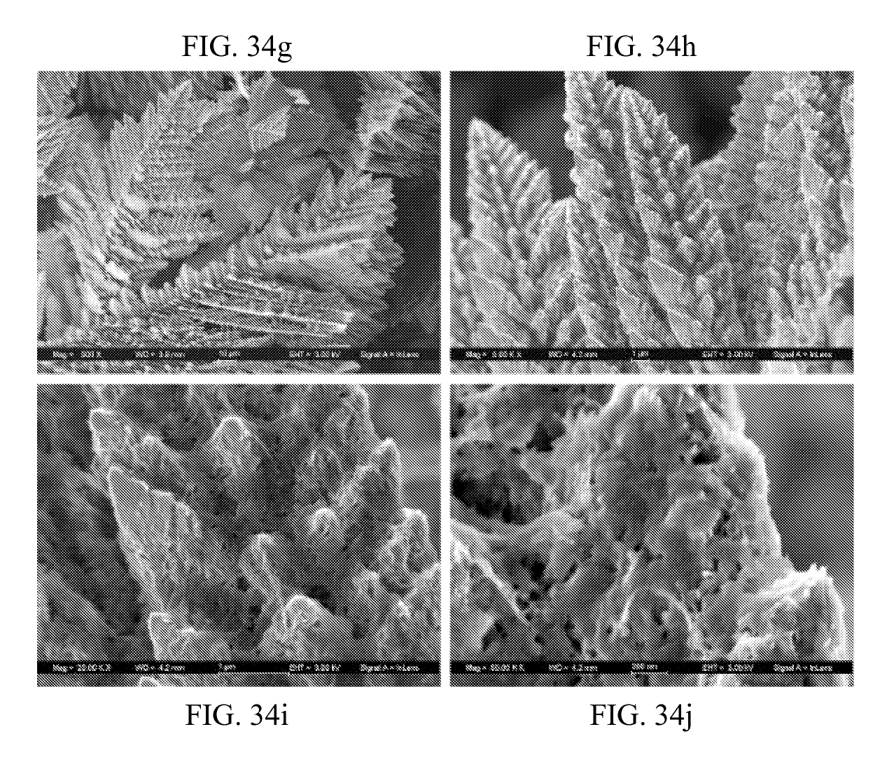

FIGS. 34a-34j show the SEM micrographs of zinc foils/electrodes for Sample 4B. Porous network-like structures formed on the anode. FIGS. 34a-34e show the anode at magnifications of 100×, 500×, 5,000×, 20,000× and 50,000× respectively. Highly porous structures are clearly observed. The structures are densely packed, and as seen in FIG. 34a, the material has cracked, forming large flakes. It appears the flakes are less than 100 nm thick.

FIGS. 34f-34j show the cathode at magnifications of 100×, 500×, 5,000×, 20,000× and 50,000× respectively. Well-defined leaf-like structures are seen on the cathode.

### Example 4C

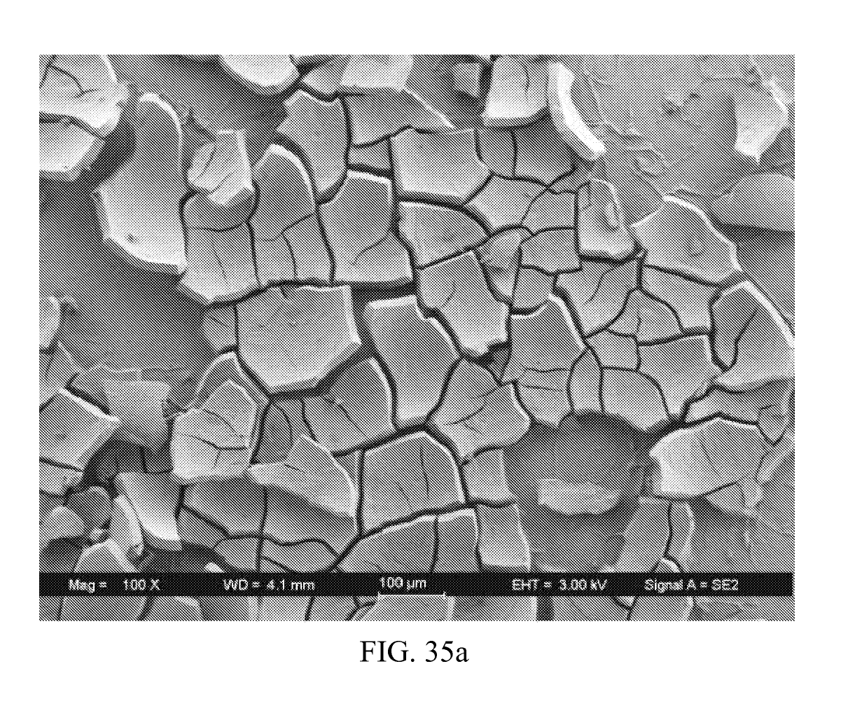

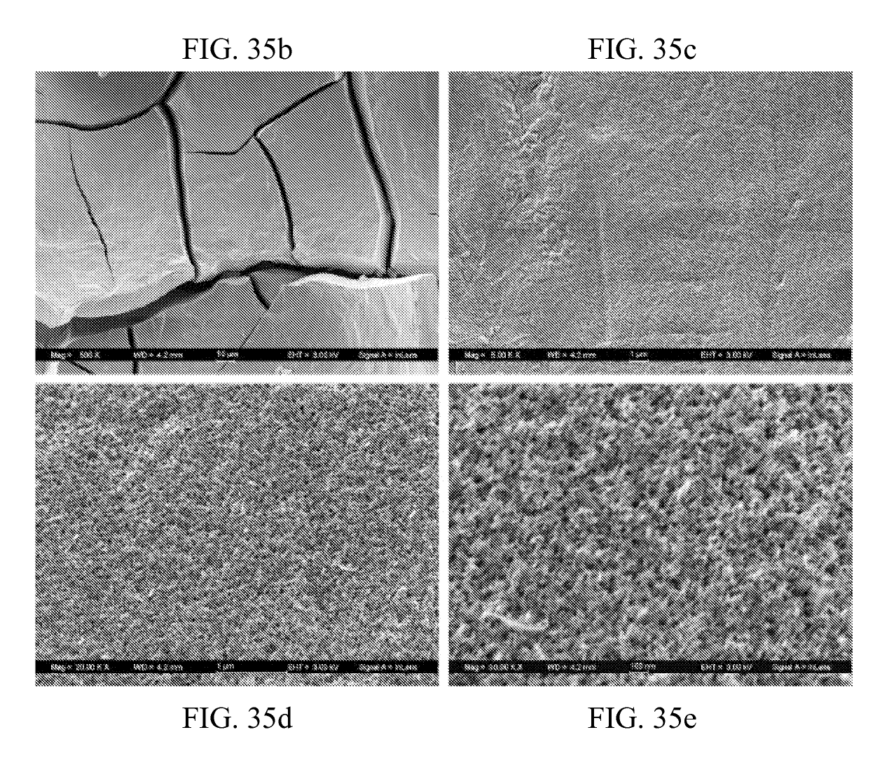

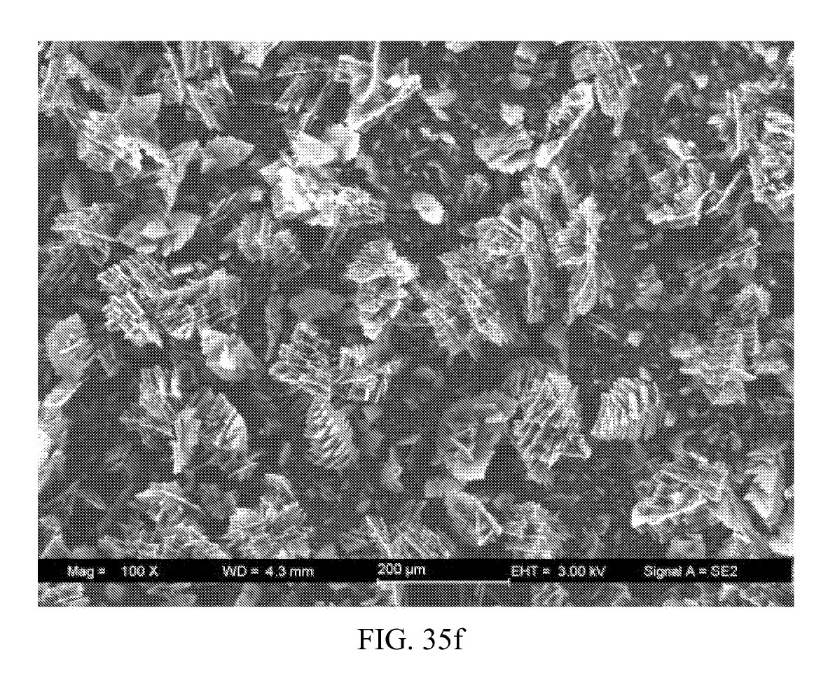

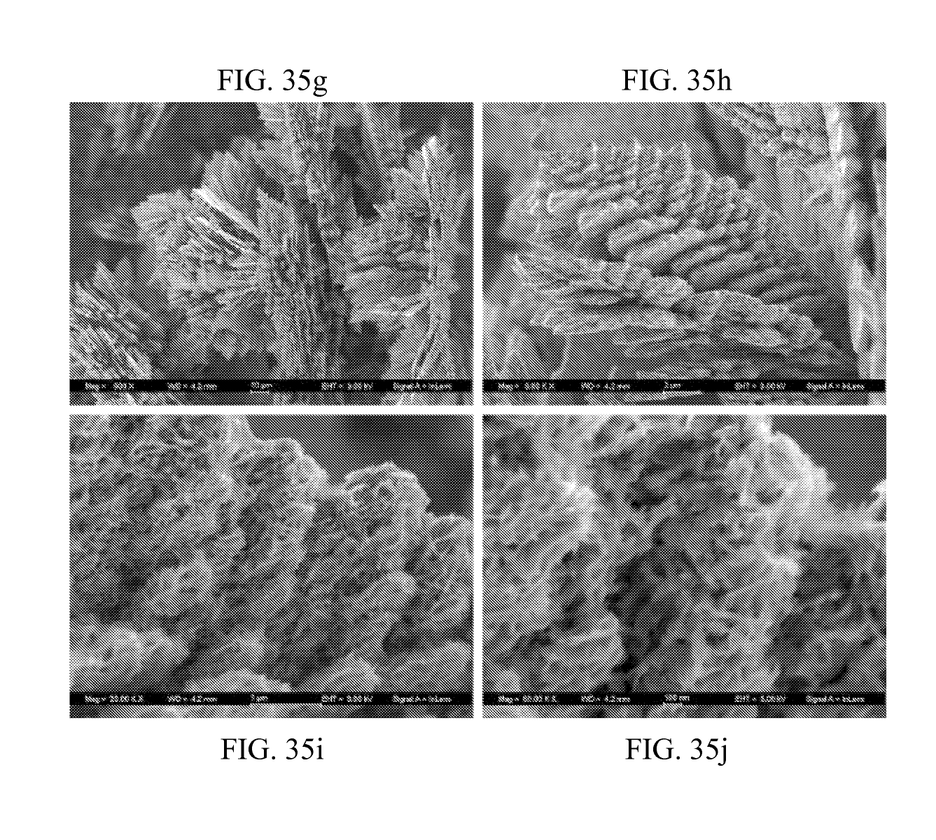

FIGS. 35a-35j show the SEM micrographs of zinc foils/electrodes for Sample 4C. Porous network-like structures formed on the anode. FIGS. 35a-35e show the anode at magnifications of 100×, 500×, 5,000×, 20,000× and 50,000× respectively. Highly porous structures are clearly observed. The structures are densely packed, and as seen in FIG. 35a, the material has cracked, forming large flakes. It appears the flakes are less than 100 nm thick.

FIGS. 35f-35j show the cathode at magnifications of 100×, 500×, 5,000×, 20,000× and 50,000× respectively. Well-defined leaf-like structures are seen on the cathode.

### Example 4D

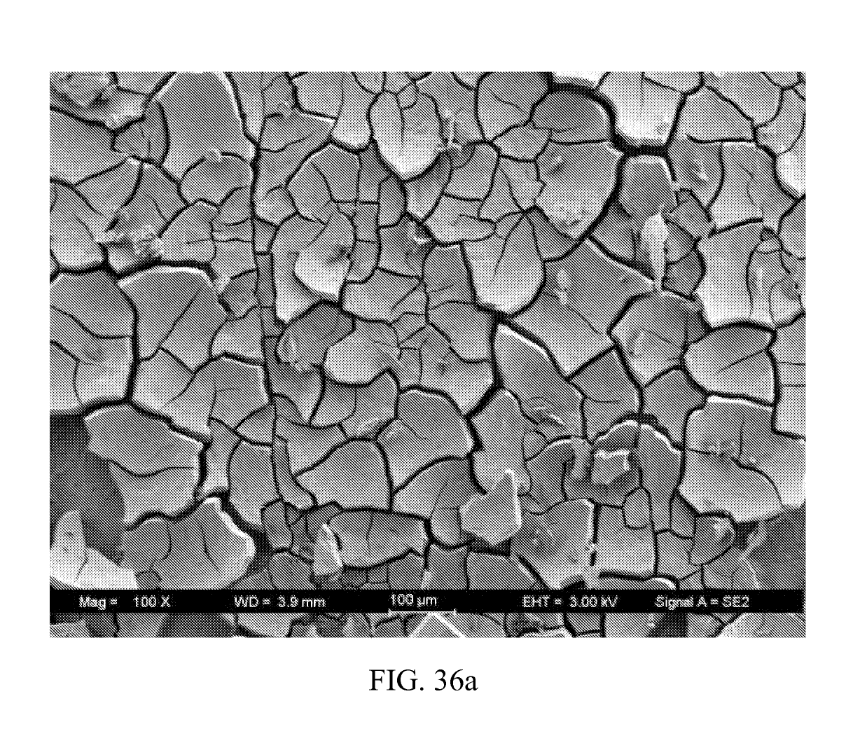

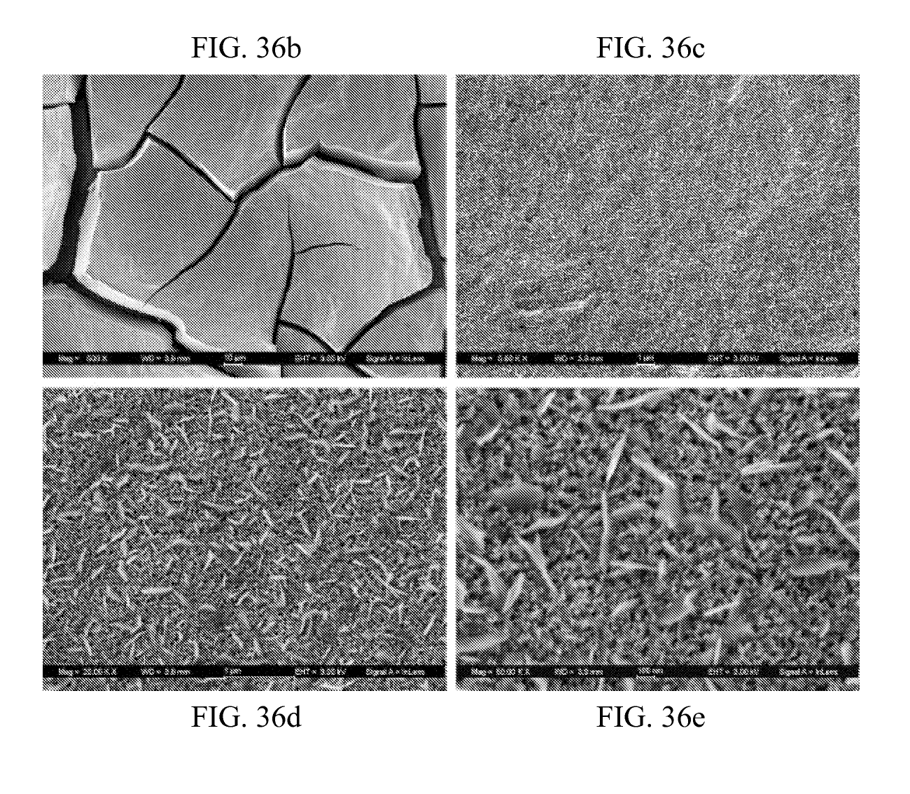

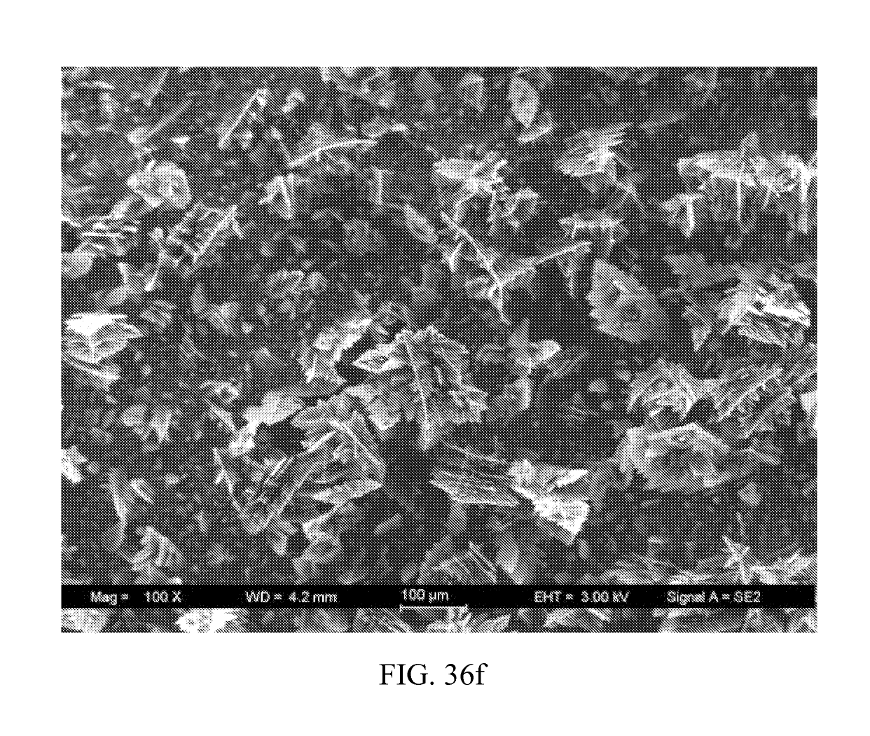

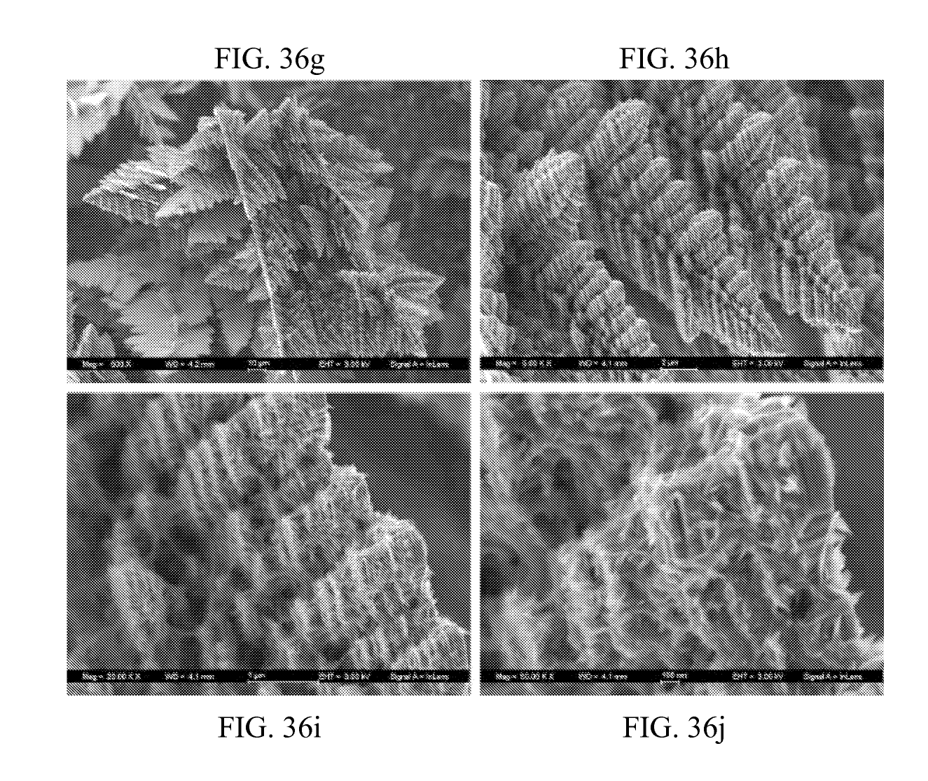

FIGS. 36a-36j show the SEM micrographs of zinc foils/electrodes for Sample 4D. Porous network-like structures formed on the anode. FIGS. 36a-36e show the anode at magnifications of 100×, 500×, 5,000×, 20,000× and 50,000× respectively. The structures are densely packed, and as seen in FIG. 36a, the material has cracked, forming large flakes. It appears the flakes are less than 100 nm thick. Additionally, secondary structures, such as platelets and needles appear on the surface of the porous network-like structure, as seen in FIG. 36e.

FIGS. 36f-36j show the cathode at magnifications of 100×, 500×, 5,000×, 20,000× and 50,000× respectively. Well-defined leaf-like structures are seen on the cathode.

### Example 4E

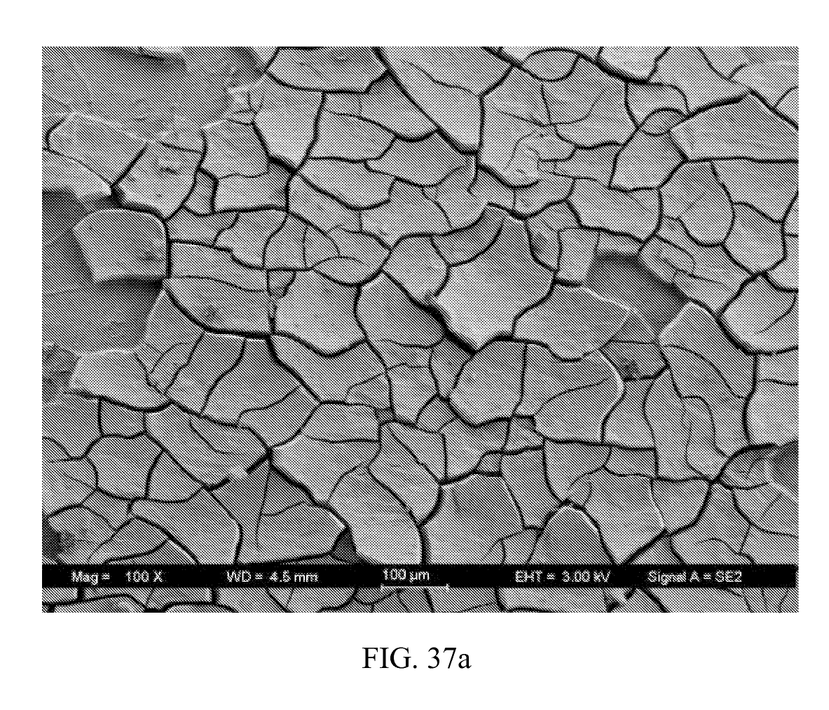

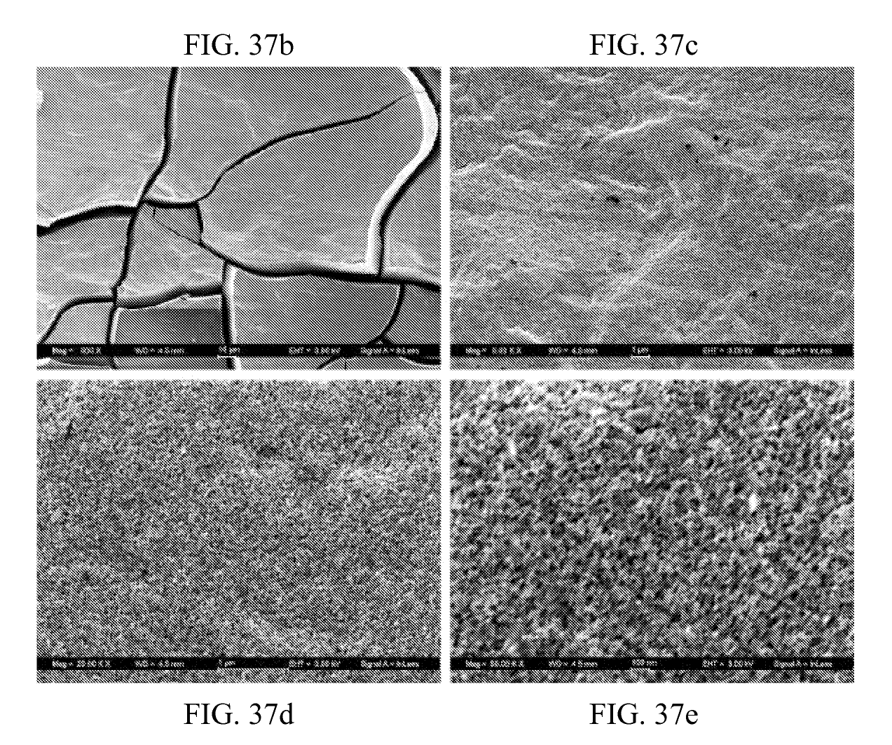

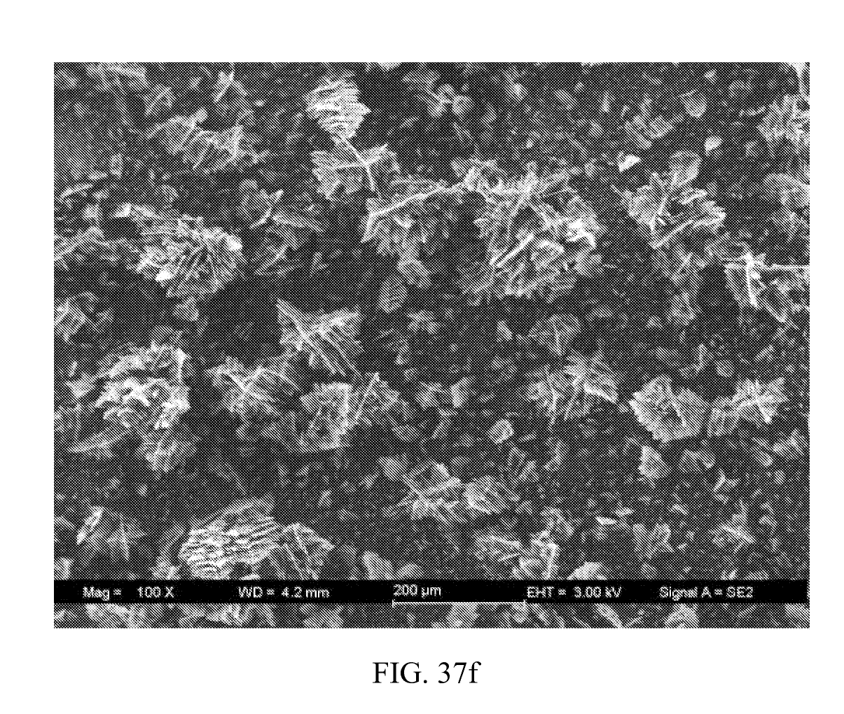

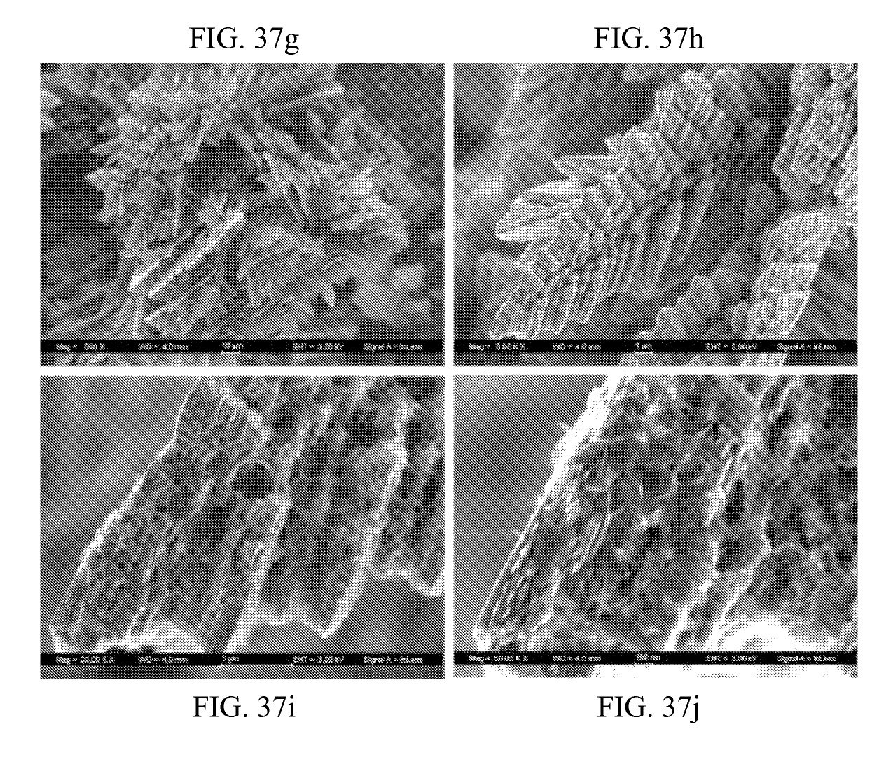

FIGS. 37a-37j show the SEM micrographs of zinc foils/electrodes for Sample 4C. Porous network-like structures formed on the anode. FIGS. 37a-37e show the anode at magnifications of 100×, 500×, 5,000×, 20,000× and 50,000× respectively. Highly porous structures are clearly observed. The structures are densely packed, and as seen in FIG. 37a, the material has cracked, forming large flakes. It appears the flakes are less than 100 nm thick.

FIGS. 37f-37j show the cathode at magnifications of 100×, 500×, 5,000×, 20,000× and 50,000× respectively. Well-defined leaf-like structures are seen on the cathode.

What is claimed is:

1. A method for making metal oxide nanostructures, comprising:
providing an electrolytic cell, which comprises an anode and a cathode disposed in an electrolyte comprising a hydroxide, wherein the anode is comprised of a metal surface exposed to the electrolyte; and
applying an electrical potential to the electrolytic cell for a period of time sufficient to obtain metal oxide nanostructures on at least the surface of the anode.

2. The method of claim 1, wherein the metal oxide nanostructures are formed on the cathode.

3. The method of claim 1, wherein the metal oxide comprises zinc oxide or cobalt oxide.

4. The method of claim 3, wherein the pH of the electrolyte comprises from about 1 M to about 10 M.

5. The method of claim 4, wherein the pH of the electrolyte comprises from about 3 M to about 8 M.

6. The method of claim 1, wherein the electrical potential comprises about 0.5V or greater.

7. The method of claim 6, wherein the electrical potential comprises from about 0.6V to about 5.0V.

8. The method of claim 3, wherein the metal oxide nanostructures comprise porous network-like, platelet-like, leaf-like, rod-like, woolly ball-like, or rosette-like nanostructures.

9. The method of claim 8, wherein the platelet-like nanostructures are aggregated.

10. The method of claim 8, wherein the leaf-like nanostructures are stacked.

11. The method of claim 8, wherein the metal oxide nanostructures further comprise secondary features.

12. The method of claim 11, wherein the secondary features have a morphology comprising cross-hatches, rods, grains, or platelets.
